(19) United States
(12) Patent Application Publication
(10) Pub. No.: US 2011/0221791 A1
(43) Pub. Date: Sep. 15, 2011

(54) IMAGE DISPLAY DEVICE

(75) Inventors: Kenta KAJIYAMA, Yotsukaido (JP); Takeshi Izumida, Mobara (JP); Naoki Tokuda, Mobara (JP); Hajime Akimoto, Kokubunji (JP); Hiroshi Kageyama, Hachioji (JP); Norihiro Nakamura, Mobara (JP); Masami Iseki, Yokohama (JP)

(73) Assignees: Hitachi Displays, Ltd.; Canon Kabushiki Kaisha

(21) Appl. No.: 13/042,495

(22) Filed: Mar. 8, 2011

(30) Foreign Application Priority Data
Mar. 12, 2010 (JP) 2010-056776

(51) Int. Cl. G09G 5/10

(52) U.S. Cl. 345/690; 345/77

(57) ABSTRACT

An image display device includes pixel circuits, a power supply line, and a data line for supplying a data signal to the pixel circuits. The pixel circuits each include a light emitting element, a drive transistor for controlling light emission of the light emitting element, a storage capacitor provided between the data line and a gate electrode of the drive transistor, a both-end connection switch for connecting both ends of the storage capacitor to each other, and a current interruption switch for interrupting a path of a current flowing from the power supply line through the both-end connection switch. Before the data signal is supplied to each of the pixel circuits, the both-end connection switch connects the both ends of the storage capacitor to each other, and the current interruption switch is disconnected.

### CROSS-REFERENCE TO RELATED APPLICATION

The present application claims priority from Japanese application JP 2010-056776 filed on Mar. 12, 2010, the content of which is hereby incorporated by reference into this application.

### BACKGROUND OF THE INVENTION

1. Field of the Invention

The present invention relates to an image display device, and more particularly, to an image display device using a light emitting element.

2. Description of the Related Art

In recent years, image display devices using a light emitting element, such as organic electroluminescent (EL) display devices, are being actively developed. Japanese Patent Application Laid-open No. 2007-148222 describes a pixel circuit for causing a light emitting element to emit light at a luminance corresponding to a gray level, and a method of driving the pixel circuit. FIG. 21 is a diagram illustrating an example of a conventional pixel circuit. The pixel circuit includes a light emitting element IL, a drive transistor TRD, a storage capacitor CP, a selecting switch SWS, an emission signal control switch SWF, a lighting control switch SWI, and a reset switch SWR. Further, a data line DAT and a power supply line PWR are provided for a column of pixel circuits, and an emission control signal line REF is provided for a row of pixel circuits. The drive transistor TRD is a p-channel transistor.

The drive transistor TRD has a source electrode connected to the power supply line PWR, and a drain electrode connected to one end of the light emitting element IL via the lighting control switch SWI. The storage capacitor CP has one end connected to a gate electrode of the drive transistor TRD. The storage capacitor CP has another end connected to the data line DAT via the selecting switch SWS and also to the emission control signal line REF via the emission signal control switch SWF. The selecting switch SWS, the emission signal control switch SWF, the lighting control switch SWI, and the reset switch SWR are thin film transistors. The thin film transistors each have a gate electrode connected to a wiring line for transmitting a control signal. Herein, a node at which the gate electrode of the drive transistor TRD is located is referred to as a node NA.

Next, a driving method for the pixel circuit of the organic EL display device illustrated in FIG. 21 is described. In a period for writing a data signal, the data signal from the data line DAT is supplied to the another end of the storage capacitor CP. At that time, the reset switch SWR is turned ON to set a gate-source potential difference of the drive transistor TRD as a threshold voltage of the drive transistor TRD. Then, when the reset switch SWR is turned OFF, the storage capacitor CP stores a potential difference obtained by subtracting the threshold voltage of the drive transistor TRD from a potential difference between a potential of the data signal and a potential of the power supply line. The period for writing the data signal is followed by a period for causing the light emitting element to emit light. In the period for causing the light emitting element to emit light, the selecting switch SWS is turned OFF, the emission signal control switch SWF is turned ON, and the lighting control switch SWI is turned ON. Then, an emission control signal is supplied from the emission control signal line REF to the another end of the storage capacitor CP, and the gate-source potential difference of the drive transistor TRD is set to a value obtained by adding to the threshold voltage a potential difference corresponding to a potential difference between the potential of the data signal and a potential of the emission control signal. As long as the threshold voltage does not change with time, the light emitting element IL emits light with a luminance determined by the potential difference between the potential of the data signal and the potential of the emission control signal irrespective of a value of the threshold voltage of the drive transistor TRD.

In this case, in order to detect the threshold voltage of the drive transistor TRD during the period for writing the data signal, it is necessary to previously set the potential of the node NA to a state low enough to turn ON the drive transistor TRD. For that purpose, the reset switch SWR and the lighting control switch SWI are previously turned ON to reduce the potential of the node NA to a potential obtained by adding to a ground potential the potential difference of the light emitting element IL (hereinafter, referred to as precharging). Note that, the lighting control switch SWI is turned OFF when the data signal is written.

This reduces the potential of the node NA, but a small amount of light is emitted because currents from the storage capacitor CP and the drive transistor TRD flow through the light emitting element IL, with the result that the contrast is reduced. To address this problem, it is possible to employ a method involving connecting the node NA to the emission control signal line REF so that a current generated from charges of the storage capacitor CP flows to the emission control signal line REF. FIG. 22 is a diagram illustrating another example of a pixel circuit of an organic EL display device. The pixel circuit illustrated in FIG. 22 is obtained by providing, to the pixel circuit illustrated in FIG. 21, a precharge switch SWP between the node NA and one end of the emission signal control switch SWF on the storage capacitor CP side. In this case, the precharge switch SWP is turned ON instead of turning ON the lighting control switch SWI. In other words, the reset switch SWR, the precharge switch SWP, and the emission signal control switch SWF are turned ON to set the potential of the node NA to the state low enough to turn ON the drive transistor TRD.

Japanese Patent Application Laid-open No. 2007-148222 discloses the organic EL display device illustrated in FIG. 21. Japanese Patent Application Laid-open No. 2007-140488 discloses the organic EL display device illustrated in FIG. 22.

When the conventional pixel circuit and driving method as illustrated in FIG. 22 are used, the small amount of light emitted from the light emitting element IL may be suppressed, but other factors may lead to degradation in image quality. An example of the degradation in image quality is described below. FIG. 23 is a diagram schematically illustrating a resistance of the emission control signal line REF in a conventional organic EL display device. This figure illustrates the resistance of the emission control signal line REF supplying a signal to pixel circuits in the middle row of rows of pixel circuits in a display area DA. The point A indicates a point at which the leftmost pixel circuit in the display area DA is connected to the emission control signal line REF, and the point B indicates a point at which the rightmost pixel circuit in the display area DA is connected to the emission control signal line REF. The emission control signal line REF is connected to a source of a reference potential Vref by a wiring line extending to the left of the display area DA in a vertical direction. In the example of this figure, a resistance between the source of the reference potential Vref and the resistance of the emission control signal line REF is 10Ω, the resistance per unit length of the emission control signal line REF is 300 Ω/mm, and the length of the emission control signal line REF is 68 mm. Further, a resistance of the drive transistor TRD is 1 MΩ, and a resistance of each of the switches SWR, SWP, and SWF is 300 kΩ at the time of precharging. FIG. 24 is a graph illustrating an amount of voltage drop Vdr in the emission control signal line REF when a through current flows from the power supply line PWR to the emission control signal line REF in the conventional organic EL display device. In the conventional organic EL display device, the amount of voltage drop Vdr at the point A is substantially 0, but the amount of voltage drop Vdr at the point B is as large as 6.4 V. When such large voltage drop occurs, the precharge operation may not be able to set the potential of the node NA to the sufficiently low state, and further, degradation in image quality, such as non-uniform luminance, may occur. The mechanism of occurrence of the non-uniform luminance due to the voltage drop is described below.

A p-channel thin film transistor such as the drive transistor TRD is known to have characteristics (hysteresis characteristics) that its threshold voltage varies with the history of potential differences applied between the gate electrode and the source electrode.

FIG. 25 is a graph illustrating the hysteresis characteristics of the p-channel thin film transistor. The threshold voltage is a gate-source potential difference (gate voltage Vg) at which a current of a certain value or more flows. It can be seen from FIG. 25 that the threshold voltage changes in a positive direction when the gate voltage Vg is changed from positive to negative (the thin film transistor is changed from OFF to ON), and that the threshold voltage changes in a negative direction when the gate voltage Vg is changed from negative to positive (the thin film transistor is changed from ON to OFF).

FIG. 26 is a graph illustrating a temporal change in amount of current to flow when a pulse signal is supplied to the gate electrode of the p-channel thin film transistor. This pulse signal indicates the amount of current to flow between the source and drain electrodes of the thin film transistor in a case of first applying a voltage in the vicinity of the threshold voltage Vth, applying a voltage in the negative direction for 0.1 s from time t1(s) to time t2=t1+0.1(s), where 0<t1<t2<1, for turning ON the thin film transistor, and then applying the voltage in the vicinity of the threshold voltage again. In this case, immediately after applying the pulse, the amount of current is reduced compared to that before the pulse is applied. Thereafter, the gate voltage is maintained at the same level so that the amount of current gradually returns to that before the pulse is applied. As the time period during which the input pulse signal is maintained becomes longer, and as the change in voltage of the input pulse becomes greater, the change in amount of current after the pulse is applied becomes greater. Note that, the thin film transistor exhibiting the hysteresis characteristics as illustrated in FIGS. 25 and 26 corresponds to the drive transistor TRD. Even when the change in amount of current due to the hysteresis characteristics or the like varies depending on the producing process, at least the threshold voltage similarly changes with the change in gate voltage Vg.

When the voltage drop occurs due to the through current in the conventional organic EL display device, the potential of the gate electrode of the drive transistor TRD varies depending on the position at which the pixel circuit PC is connected to the emission control signal line REF. Accordingly, the gate-source potential difference of the drive transistor TRD also changes. The potential difference after the change is applied while the precharge operation is performed, to thereby change the threshold voltage of the drive transistor TRD. In a period for storing the data signal after the precharge operation, the threshold voltage is yet to return to the original value, but the storage capacitor CP stores the potential difference to cancel the threshold voltage. On the other hand, the threshold voltage returns to the value corresponding to the luminance during the period for emitting light, and hence the threshold voltage is different for the timing for storing the data signal and the period for emitting light. This difference leads to the difference in amount of current to flow through the drive transistor TRD, which is seen as the difference in luminance on the display area (non-uniform luminance).

As described above, in the conventional image display device in which the potential of the node, to which the gate electrode of the drive transistor is connected, is reduced without causing the current to flow through the light emitting element, there may occur the degradation in image quality due to the voltage drop or the like, for example, the difference in luminance of the emitted light depending on the connection position of the pixel circuit and the wiring line in which the voltage drop occurs.

### SUMMARY OF THE INVENTION

The present invention has been made in view of the above-mentioned problem, and an object of the present invention is to provide an image display device in which data is written without accompanying light emission to suppress degradation in image quality due to hysteresis characteristics of a drive transistor TRD.

Typical aspects of the invention disclosed in the subject application are briefly summarized as follows.

(1) An image display device, including: a plurality of pixel circuits; a power supply line; and a data line for supplying a data signal to the plurality of pixel circuits, in which: each of the plurality of pixel circuits includes: a light emitting element; a drive transistor for controlling light emission of the light emitting element; a storage capacitor provided between the data line and a gate electrode of the drive transistor; a both-end connection switch for connecting both ends of the storage capacitor to each other; and a current interruption switch for interrupting a path of a current flowing from the power supply line via the both-end connection switch; and before the data line supplies the data signal to each of the plurality of pixel circuits, the both-end connection switch included in corresponding one of the plurality of pixel circuits connects the both ends of the storage capacitor to each other, and the current interruption switch included in corresponding one of the plurality of pixel circuits interrupts the path of the current.

(2) In the image display device of item (1), the current interruption switch included in each of the plurality of pixel circuits is provided between a drain electrode and the gate electrode of the drive transistor included in corresponding one of the plurality of pixel circuits.

(3) An image display device, including: a plurality of pixel circuits; a power supply line; and a data line for supplying a data signal to the plurality of pixel circuits, in which each of the plurality of pixel circuits includes: a light emitting element having one end to which a reference potential is supplied; a drive transistor; a lighting control switch having one end connected to a drain electrode of the drive transistor and another end connected to another end of the light emitting element; a storage capacitor having one end connected to a gate electrode of the drive transistor; a reset switch provided between the gate electrode and the drain electrode of the drive transistor; a both-end connection switch having one end connected to the one end of the storage capacitor and another end connected to another end of the storage capacitor; an auxiliary capacitor having one end connected to one of the one end and the another end of the storage capacitor; and a selecting switch having one end connected to the data line and another end connected to the another end of the storage capacitor.

(4) An image display device, including: a plurality of pixel circuits; a power supply line; an emission control signal line for supplying an emission control signal for causing the plurality of pixel circuits to emit light; and a data line for supplying a data signal to the plurality of pixel circuits, in which each of the plurality of pixel circuits includes: a light emitting element having one end to which a reference potential is supplied; a drive transistor; a lighting control switch having one end connected to a drain electrode of the drive transistor and another end connected to another end of the light emitting element; a storage capacitor having one end connected to a gate electrode of the drive transistor; a reset switch provided between the gate electrode and the drain electrode of the drive transistor; a both-end connection switch having one end connected to the one end of the storage capacitor and another end connected to another end of the storage capacitor; an auxiliary capacitor having one end connected to one of the one end and the another end of the storage capacitor; a selecting switch having one end connected to the data line and another end connected to the another end of the storage capacitor; and an emission signal control switch having one end connected to the emission control signal line and another end connected to the another end of the storage capacitor.

(5) A driving method for an image display device including a power supply line, a data line, and pixel circuits each including a light emitting element, a drive transistor for controlling light emission of the light emitting element, a storage capacitor provided between the data line and a gate electrode of the drive transistor, and a both-end connection switch for connecting both ends of the storage capacitor to each other, the driving method including: a precharge step of connecting the both ends of the storage capacitor to each other through the both-end connection switch, and interrupting a path of a current flowing from the power supply line through the both-end connection switch; after the precharge step, a data storing step of inputting, by the data line, a data signal to one end of the storage capacitor on the data line side; and after the data storing step, an emission step of supplying an emission control signal to the one end of the storage capacitor to cause the light emitting element to emit light.

(6) In the driving method for an image display device of item (5): the drive transistor has a source electrode to which a power supply potential is supplied; and the precharge step includes connecting the both ends of the storage capacitor to each other through the both-end connection switch, and interrupting the path of the current between a drain electrode and the gate electrode of the drive transistor.

(7) In the driving method for an image display device of item (5) or (6), the precharge step includes setting the both ends of the storage capacitor to a floating state.

(8) In the driving method for an image display device of item (5) or (6): the image display device further includes an emission control signal line; and the precharge step includes supplying a potential to the one end of the storage capacitor on the data line side through the emission control signal line.

(9) In the driving method for an image display device of any one of items (5) to (8), the precharge step is performed for a period longer than one horizontal period.

(10) In the driving method for an image display device of item (5) or (6), the precharge step includes supplying a potential to the one end of the storage capacitor through the data line.

(11) In the driving method for an image display device of any one of items (5) to (7), a combination of the precharge step and the data storing step is repeated before the emission step is performed.

In the image display device according to the present invention, data is written without accompanying light emission so that the degradation in image quality due to the hysteresis characteristics of the drive transistor TRD may be suppressed.

### BRIEF DESCRIPTION OF THE DRAWINGS

In the accompanying drawings:

FIG. 1 is a diagram illustrating an example of a circuit configuration of an organic electroluminescent (EL) display device according to a first embodiment of the present invention;

FIG. 2 is a circuit diagram illustrating an example of a configuration of a pixel circuit according to the first embodiment of the present invention;

FIG. 3 is a waveform diagram illustrating an example of temporal changes in potentials of RGB change-over control lines, a lighting control line, a precharge control line, a reset control line, a node NA, and a node NB of the pixel circuit according to the first embodiment of the present invention;

FIG. 4A is a diagram illustrating states of switches in the pixel circuit in a precharge period;

FIG. 4B is a diagram illustrating states of the switches in the pixel circuit in a data storing period;

FIG. 4C is a diagram illustrating states of the switches in the pixel circuit in an emission period;

FIG. 4D is a diagram illustrating states of the switches in the pixel circuit at a time when light is not emitted;

FIG. 5 is a circuit diagram illustrating an example of a configuration of a pixel circuit according to a second embodiment of the present invention;

FIG. 6 is a waveform diagram illustrating an example of temporal changes in potentials of RGB change-over control lines, a lighting control line, a precharge control line, a reset control line, a node NA, and a node NB of the pixel circuit according to the second embodiment of the present invention;

FIG. 7A is a diagram illustrating states of switches in the pixel circuit in a precharge period;

FIG. 7B is a diagram illustrating states of the switches in the pixel circuit in a data storing period;

FIG. 7C is a diagram illustrating states of the switches in the pixel circuit in an emission period;

FIG. 8 is a waveform diagram illustrating another example of temporal changes in potentials of the RGB change-over control lines, the lighting control line, the precharge control line, the reset control line, the node NA, and the node NB when gray is displayed;

FIG. 9 is a waveform diagram illustrating an example of a driving method including repeating a precharge operation and a data storing operation a plurality of times;

FIG. 10 is a circuit diagram illustrating an example of a configuration of a pixel circuit according to a third embodiment of the present invention;

FIG. 11 is a waveform diagram illustrating an example of temporal changes in potentials of RGB change-over control lines, a lighting control line, a precharge control line, a reset control line, a node NA, and a node NB of the pixel circuit according to the third embodiment of the present invention;

FIG. 12 is a diagram illustrating states of switches in the pixel circuit in a precharge period;

FIG. 13 is a waveform diagram illustrating another example of temporal changes in potentials of the RGB change-over control lines, the lighting control line, the precharge control line, the reset control line, the node NA, and the node NB of the pixel circuit according to the third embodiment of the present invention;

FIG. 14 is a circuit diagram illustrating an example of a configuration of a pixel circuit according to a fourth embodiment of the present invention;

FIG. 15 is a waveform diagram illustrating an example of temporal changes in potentials of RGB change-over control lines, a lighting control line, a precharge control line, a reset control line, a selection control line, a node NA, and a node NB of the pixel circuit according to the fourth embodiment of the present invention;

FIG. 16 is a diagram illustrating states of switches in the pixel circuit in a precharge period;

FIG. 17 is a circuit diagram illustrating another example of the configuration of the pixel circuit according to the fourth embodiment of the present invention;

FIG. 18 is a diagram illustrating an example of the pixel circuit in which one end of a precharge switch is connected to an emission control signal line;

FIG. 19 is a diagram illustrating an example of the pixel circuit consisting only of p-channel thin film transistors;

FIG. 20 is a diagram illustrating an example of the pixel circuit without an emission control signal line;

FIG. 21 is a diagram illustrating an example of a pixel circuit of a conventional organic EL display device;

FIG. 22 is a diagram illustrating another example of the pixel circuit of the organic EL display device;

FIG. 23 is a diagram schematically illustrating a resistance of an emission control signal line in the conventional organic EL display device;

FIG. 24 is a graph illustrating voltage drop in the emission control signal line when a through current flows from a power supply line to the emission control signal line in the conventional organic EL display device;

FIG. 25 is a graph illustrating hysteresis characteristics of a p-channel thin film transistor; and

FIG. 26 is a graph illustrating a temporal change in amount of current to flow when a pulse signal is supplied to a gate electrode of the p-channel thin film transistor.

### DETAILED DESCRIPTION OF THE INVENTION

Hereinafter, embodiments of the present invention are described with reference to the accompanying drawings. Throughout the description, the same reference symbols are attached to components having the same function, and redundant description thereof is omitted. Note that, in the following, a case where the present invention is applied to an organic electroluminescent (EL) display device, which is a type of an image display device using a light emitting element, is described.

### First Embodiment

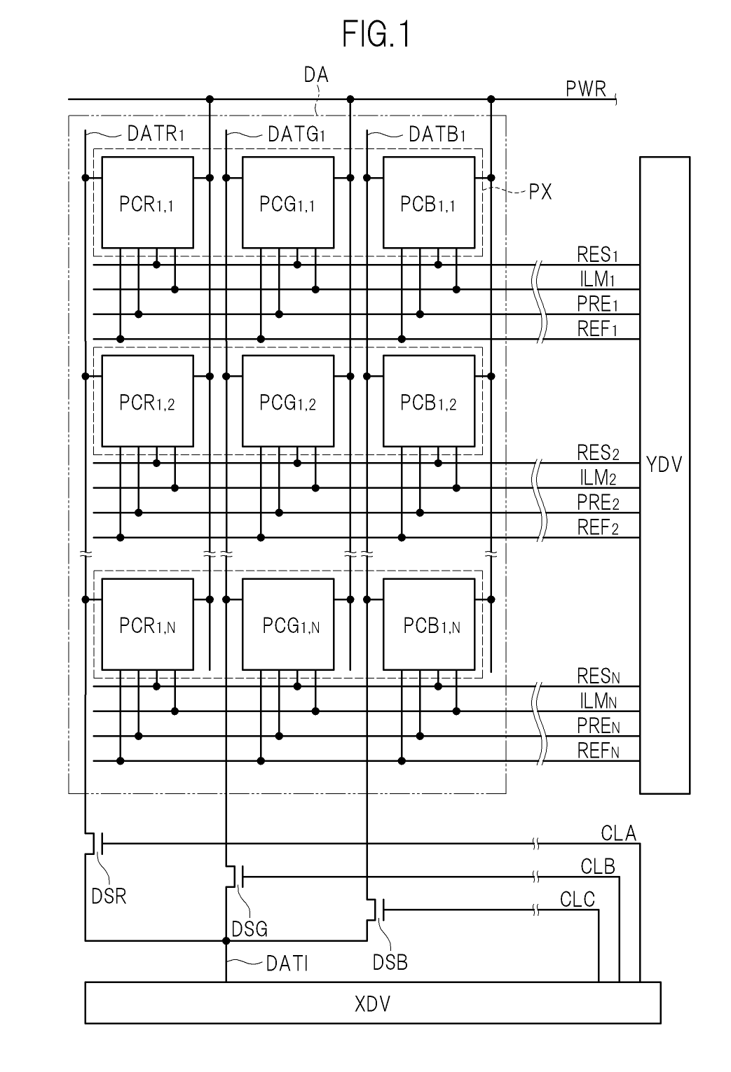

An organic EL display device physically includes an array substrate, a flexible printed circuit board, and a driver integrated circuit encapsulated in a package. On the array substrate, a display area DA for displaying an image is provided. FIG. 1 is a diagram illustrating an example of a circuit configuration of the organic EL display device according to a first embodiment of the present invention. The circuit illustrated in FIG. 1 is mainly provided on the array substrate and in the driver integrated circuit. The display area DA is formed on the array substrate of the organic EL display device, and the display area DA includes pixels arranged in matrix. In each pixel region, three pixel circuits PCR, PCG, PCB are arranged side by side in the horizontal direction of the figure. The pixel circuit PCR displays red, the pixel circuit PCG displays green, and the pixel circuit PCB displays blue. Hereinafter, the pixel circuits PCR, PCB, and PCG are referred to as pixel circuits PC when distinction among emission colors is unnecessary. Note that, pixels PX are arranged in M columns and N rows in the display area DA. Note that, the red pixel circuit PCR, the green pixel circuit PCG, and the blue pixel circuit PCB constituting the pixel PX in n-th row and m-th column are denoted by PCR_{m,n}, PCG_{m,n}, and PCB_{m,n}, respectively. Further, the pixel circuits PC are arranged in (3×M) columns and N rows in the display area, and in this embodiment, the pixel circuits PC arranged in the same column display the same color.

In the display area DA, a data line DATR, DATG, or DATB (hereinafter, referred to as data line DAT when distinction among data lines is unnecessary) and a power supply line PWR for supplying a power supply potential Voled extend for each column of the pixel circuits PC in the vertical direction of the figure, and a reset control line RES, a lighting control line ILM, a precharge control line PRE, and an emission control signal line REF extend for each row of the pixel circuits PC in the horizontal direction of the figure. Further, in an area on the array substrate and below the display area DA in the figure, RGB change-over switches DSR, DSG, and DSB respectively provided for the data lines DATR, DATG, and DATB, an integrated data line DATI, a data line driving circuit XDV, and a vertical scanning circuit YDV are provided. Note that, parts of the data line driving circuit XDV and the vertical scanning circuit YDV are also provided in the driver integrated circuit.

The pixel circuits PC connected to the same data line DAT display the same color. Hereinafter, the data lines DATR, DATG, and DATB for the columns of the pixel circuits PCR, PCG, and PCB constituting the pixels in the m-th column are denoted by DATRm, DATGm, and DATBm, respectively. A data line DAT supplies a data signal to a plurality of pixel circuits PC in the corresponding column. Further, the number of the reset control lines RES, the number of the lighting control lines ILM, the number of the precharge control lines PRE, and the number of the emission control signal lines REF are the same as the number (N) of rows of the pixel circuits PC. The reset control line RES, the lighting control line ILM, the precharge control line PRE, and the emission control signal line REF corresponding to the n-th row of the pixel circuits PC are denoted by RESn, ILMn, PREn, and REFn, respectively. One end of each of the reset control line RES, the lighting control line ILM, the precharge control line PRE, and the emission control signal line REF is connected to the vertical scanning circuit YDV.

The RGB change-over switches DSR, DSG, and DSB are n-channel thin film transistors and respectively provided in the number m corresponding to the number of columns of the pixels. The RGB change-over switch DSR has a gate electrode connected to an RGB change-over control line CLA, the RGB change-over switch DSG has a gate electrode connected to an RGB change-over control line CLB, and the RGB change-over switch DSB has a gate electrode connected to an RGB change-over control line CLC.

Of the data lines DAT corresponding to the m-th column of the pixels, the data line DATRm for the pixel circuits PCR has a lower end connected to one end of the RGB change-over switch DSR. Another end of the RGB change-over switch DSR is connected to one end of the integrated data line DATI corresponding to the m-th column of the pixels, of the integrated data lines DATI provided in the number M corresponding to the number of the columns of the pixels. Similarly, the data line DATGm has a lower end connected to the one end of the corresponding integrated data line DATI via the RGB change-over switch DSG, and the data line DATBm has a lower end connected to the one end of the corresponding integrated data line DATI via the RGB change-over switch DSB. Another end of the integrated data line DATI is connected to the data line driving circuit XDV.

Note that, the RGB change-over switches DSR, DSG, DSB each have a drain electrode connected to the integrated data line DATI, and a source electrode connected to the corresponding data line DAT. Note that, polarities of the source electrode and the drain electrode of the thin film transistor are not structurally determined, but are determined by the direction of the current flowing through the thin film transistor and whether the thin film transistor is of the n-channel type or the p-channel type. Therefore, the connection destinations of the source electrode and the drain electrode of the thin film transistor may be interchanged.

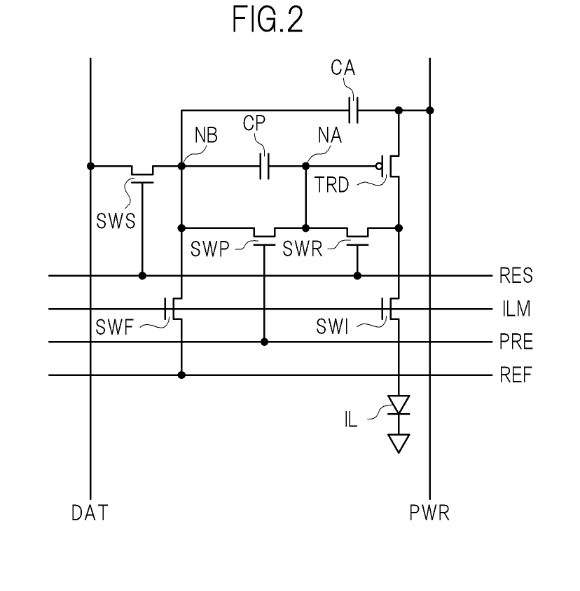

FIG. 2 is a circuit diagram illustrating an example of a configuration of a pixel circuit PC according to the first embodiment of the present invention. The pixel circuit PC includes a light emitting element IL, a drive transistor TRD, a storage capacitor CP, an auxiliary capacitor CA, a lighting control switch SWI, a reset switch SWR, a selecting switch SWS, an emission signal control switch SWF, and a precharge switch SWP. The light emitting element IL has one end to which a reference potential is supplied by a reference potential supply wiring line (not shown). The drive transistor TRD is a p-channel thin film transistor and controls an amount of light emitted from the light emitting element IL depending on a potential difference between potentials applied to a gate electrode and a source electrode thereof. The light emitting element IL has another end connected to a drain electrode of the drive transistor via the lighting control switch SWI. The storage capacitor CP has one end connected to the gate electrode of the drive transistor TRD. The storage capacitor CP has another end connected to one end of the selecting switch SWS, and another end of the selecting switch SWS is connected to the data line DAT. The another end of the storage capacitor CP is also connected to one end of the emission signal control switch SWF. Another end of the emission signal control switch SWF is connected to the emission control signal line REF. In this example, a node to which the gate electrode of the drive transistor TRD is connected is referred to as a node NA, and a node to which the another end of the storage capacitor CP is connected is referred to as a node NB. Note that, the light emitting element IL included in the pixel circuit PCR emits red light, the light emitting element IL included in the pixel circuit PCG emits green light, and the light emitting element IL included in the pixel circuit PCB emits blue light.

The auxiliary capacitor CA has one end connected to the node NB and another end connected to the source electrode of the drive transistor TRD. The auxiliary capacitor CA assists a series of precharge operations to be described later. Specifically, the auxiliary capacitor CA suppresses the increase in potentials of the node NA and the node NB, which are floating at the time of the precharge operations, by being coupled with the precharge control line PRE, and prevents an increase in on-state resistance of the precharge switch SWP. The gate electrode and the drain electrode of the drive transistor TRD are connected to each other via the reset switch SWR. Further, the one end of the storage capacitor CP is connected to one end of the precharge switch SWP, and the another end of the storage capacitor CP is connected to another end of the precharge switch SWP. The precharge switch SWP serves as a both-end connection switch for electrically connecting both ends of the storage capacitor CP to each other. The lighting control switch SWI, the reset switch SWR, the selecting switch SWS, the emission signal control switch SWF, and the precharge switch SWP are n-channel thin film transistors. The selecting switch SWS and the reset switch SWR each have a gate electrode connected to the reset control line RES. The lighting control switch SWI and the emission signal control switch SWF each have a gate electrode connected to the lighting control line ILM, and the precharge switch SWP has a gate electrode connected to the precharge control line PRE.

Note that, the reference potential is a potential which serves as a reference with respect to the power supply potential Voled supplied from the power supply line PWR, and the potential supplied to the data line DAT and the gate electrode of the thin film transistor TRD used for switching the lighting control switch SWI or the like. The reference potential may not necessarily be supplied from a grounded electrode.

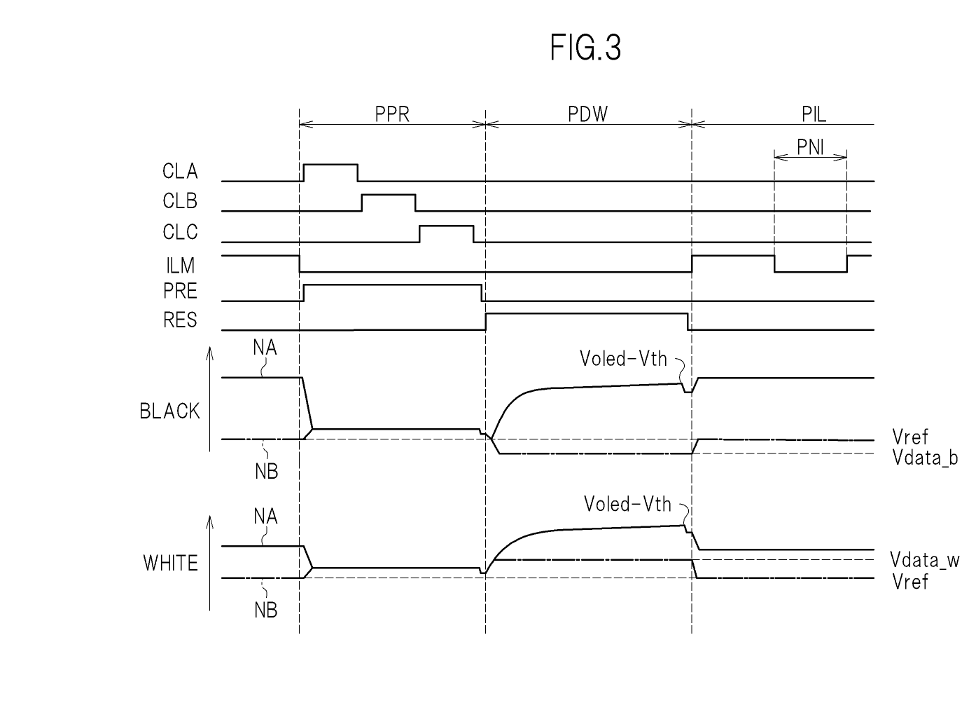

Next, a driving method for the organic EL display device according to this embodiment is described. FIG. 3 is a waveform diagram illustrating an example of temporal changes in potentials of the RGB change-over control lines CLA, CLB, and CLC, the lighting control line ILM, the precharge control line PRE, the reset control line RES, the node NA, and the node NB. In this figure, signals for only one pixel circuit PC are illustrated. The potentials of the node NA and the node NB are illustrated for two cases: one where a frame (hereinafter, referred to as previous frame) immediately preceding the current frame displays black and the current frame displays black (BLACK); and the other where the previous frame displays white and the current frame displays white (WHITE).

Operations for light emission of one pixel circuit PC are performed in the order of a precharge operation, a data storing operation, and an emission operation. The precharge operation is an operation of lowering the gate potential of the drive transistor TRD, and a period in which this operation is performed is referred to as a precharge period PPR. The data storing operation is an operation of storing the potential difference corresponding to the gray level to be displayed in the storage capacitor CP, and a period in which this operation is performed is referred to as a data storing period PDW. The emission operation is an operation of causing the light emitting element IL to emit light, and a period in which this operation is performed is referred to as an emission period PIL. In this example, the precharge period PPR and the data storing period PDW are performed in succession, and a period for the both operations is one horizontal period (1H). The pixel circuits PC are arranged in matrix, and the rows are scanned sequentially, one for each horizontal period. In the example of this figure, when the pixel circuits PC in the n-th row are in the precharge period PPR or the data storing period PDW, the pixel circuits PC in rows other than the n-th row are in the emission period PIL. In the next horizontal period 1H, the pixel circuits PC in the (n+1) th row are in the precharge period PPR or the data storing period PDW, and the pixel circuits PC in rows other than the (n+1) th row are in the emission period PIL. Note that, scanning of the last row in the display area DA is followed by a vertical blanking interval, and then sequential scanning is started again from the first row to display the next frame.

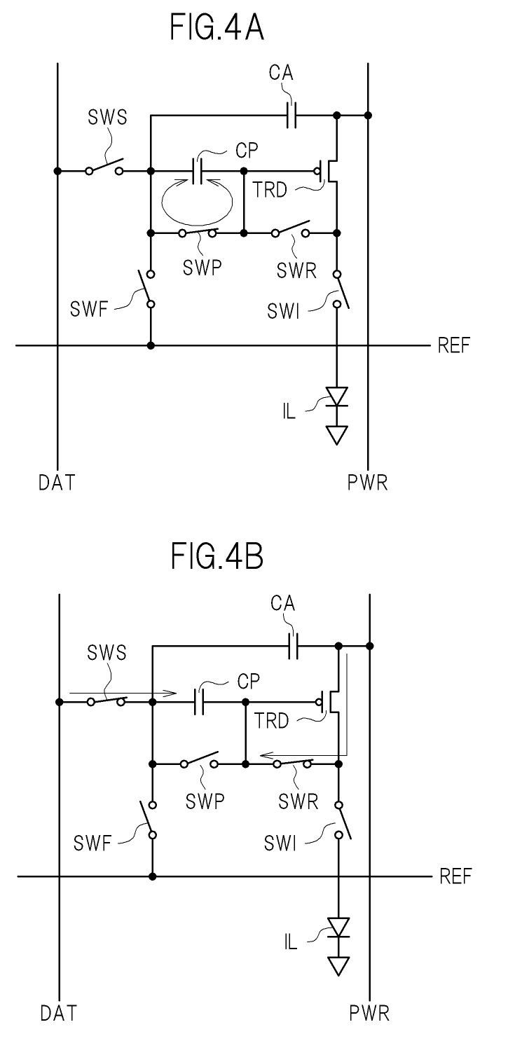

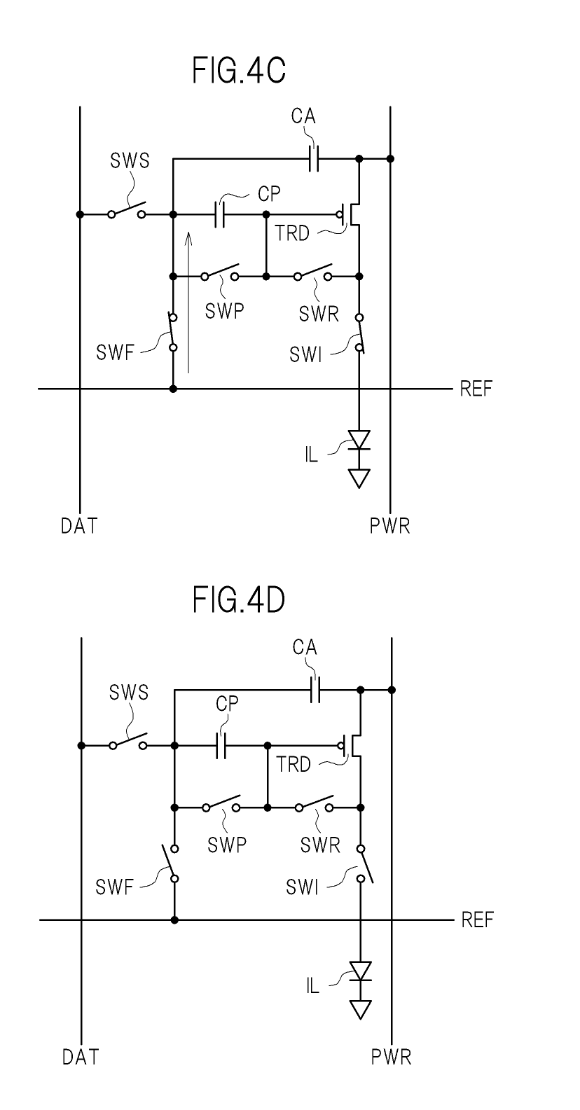

FIGS. 4A to 4D are diagrams illustrating states of the lighting control switch SWI, the reset switch SWR, the selecting switch SWS, the emission signal control switch SWF, and the precharge switch SWP in the pixel circuit PC in the respective periods of the example illustrated in FIG. 3. Referring to FIGS. 3 and 4A to 4D, the driving method, a potential Va of the node NA, and a potential Vb of the node NB are described below.

Before the precharge period PPR, the light emitting element IL emits light at the gray level displayed in the previous frame. In other words, the pixel circuit is in the emission period PIL of the previous frame. In the emission period PIL of the previous frame, the potential of the node NA is a potential corresponding to the gray level at which the light is emitted. The potential becomes higher as the displayed gray level becomes closer to dark (black) and farther from bright (white). At the beginning of the precharge period PPR, the auxiliary capacitor CA stores the potential difference between the power supply line PWR and the emission control signal line REF applied in the emission period PIL of the previous frame, to thereby suppress the increase in potentials of the node NA and the node NB, which are floating at the time when the precharge switch SWP is turned ON, by being coupled to the precharge control line, and suppress the increase in on-state resistance of the precharge switch SWP. At the beginning of the precharge period PPR, the potential of the lighting control line ILM becomes LOW and the lighting control switch SWI is turned OFF. This stops light emission of the light emitting element IL. Shortly after that, the potential of the precharge control line PRE becomes HIGH and the precharge switch SWP is turned ON. FIG. 4A is a diagram illustrating this state. At this time, the potential of the reset control line RES is LOW, and the selecting switch SWS and the reset switch SWR are OFF. When the precharge switch SWP is turned ON, the both ends of the storage capacitor CP are connected to each other to have the same potential.

The potential difference stored in the auxiliary capacitor CA causes the potential of the node NA to become a potential closer to the potential Vb (Vref) at the beginning of the precharge period PPR than the potential Vb at that time. The potential Va becomes substantially the same potential even when the gray level of the previous frame is different, and the gate-source voltage of the drive transistor TRD is maintained at the negative direction. In this embodiment, in the precharge period PPR, the gate-source voltage of the drive transistor TRD becomes a negative voltage even when the gray level in the previous frame is different. This allows the uniform threshold voltage (hysteresis) to be attained. Further, the low potential Va results in low on-state resistance of the precharge switch SWP so that the time it takes for the potential Va to change is reduced compared to the case where the auxiliary capacitor CA is not provided.

At this time, the reset switch SWR is OFF, and a current path from the power supply line PWR to the emission control signal line REF is interrupted. In other words, the reset switch SWR serves as a current interruption switch for interrupting the current path from the power supply line through the both-end connection switch SWP to the emission control signal line REF. Note that, when the gray level in the previous frame is black (hereinafter, referred to as the case of the previous frame is black), the potential Va before the precharge operation is the potential at which the drive transistor TRD is turned OFF, and when the gray level in the previous frame is white (hereinafter, referred to as the case where the previous frame is white), the potential Va before the precharge operation is the potential at which the current for causing the light emitting element IL to emit light at the highest gray level is caused to flow through the drive transistor TRD. In this embodiment, the potential Va in the case where the previous frame is white is lower than that in the case where the previous frame is black by 5 V.

Further, in the example of FIG. 3, the data line driving circuit XDV sequentially supplies the data signal to the data lines DATR, DATG, and DATB in the precharge period PPR. At the beginning of the precharge period PPR, the RGB change-over control line CLA becomes HIGH and the RGB change-over switch DSR is turned ON so that the integrated data line DATI and the data line DATR are connected to each other. The data line driving circuit XDV writes the data signal through the integrated data line DATI to the data line DATR. Next, the RGB change-over control line CLB becomes HIGH in place of the RGB change-over control line CLA, and the data line driving circuit XDV writes the data signal through the integrated data line DATI to the data line DATG. Similarly, the RGB change-over control line CLC becomes HIGH in place of the RGB change-over control line CLB, and the data line driving circuit XDV writes the data signal through the integrated data line DATI to the data line DATB. After writing to the data line, the RGB change-over switch DSB is turned OFF. Parasitic capacitance is generated between the data lines DATR, DATG, and DATB and wiring lines extending horizontally, such as the reset control line RES, and the parasitic capacitance causes the potential of the data signal supplied from the data line driving circuit XDV to be stored in each of the data lines DAT.

At the end of the precharge period PPR, the potential of the precharge control line PRE becomes LOW and the precharge switch SWP is turned OFF. Then, at the beginning of the data storing period PDW, the potential of the reset control line RES becomes HIGH, and the selecting switch SWS and the reset switch SWR are turned ON. FIG. 4B is a diagram illustrating states of the switches in the data storing period PDW. With this state, the potential of the data signal stored in the data line DAT is supplied to the one end of the storage capacitor CP on the node NB side, and the node NA, to which the another end of the storage capacitor CP is connected, is connected to the drain electrode of the drive transistor TRD.

At the beginning of the data storing period PDW, the potential Va is a potential low enough to turn ON the drive transistor TRD, and hence the drive transistor TRD causes the current to flow so that the gate-source potential difference becomes the threshold voltage both for the case where the previous frame is black and for the case where the previous frame is white. However, when the gray level to be displayed is black, the potential Va is temporarily reduced by coupling. Thereafter, Va approaches Voled-|Vth|, where Vth is the value of the threshold voltage. Then, at the end of the data storing period PDW, the storage capacitor CP stores the potential differences between the potential Va of the node NA and potentials Vdata_b (potential at the gray level of black), Vdata_w (potential at the gray level of white), or the like of the data signals. Note that, in actuality, a time constant it takes for the potential difference to reach to the threshold voltage is larger than the data storing period PDW. Therefore, at the timing when the data storing period PDW ends, the potential Va is smaller than Voled-|Vth|, and the storage capacitor CP stores the potential difference that reflects the potential Va.

In the next emission period PIL, the potential of the lighting control line ILM becomes HIGH, and the lighting control switch SWI and the emission signal control switch SWF are turned ON to supply the reference potential Vref, which is a potential for light emission, to the node NB. FIG. 4C is a diagram illustrating states of the switches at this timing. The current flowing through the drive transistor TRD changes depending on the potential difference between the potential of the data signal and the reference potential Vref.

Specifically, the potential Va of the node NA at that point in time is expressed as follows:

Va=Voled-|Vth|−(Vdata−Vref)

The amount of the current flowing through the drive transistor TRD is determined by a value obtained by subtracting the threshold voltage from the gate-source potential difference, and hence the amount of the current may be controlled irrespective of the fluctuation in threshold voltage at the time of manufacture of the drive transistor TRD. Accordingly, the light emitting element IL emits light at a luminance corresponding to the potential of the data signal. Note that, there are cases where, in order to adjust the emission luminance of the entire display area DA for the purposes of, for example, addressing the difference in brightness between outdoor and indoor environments, a period (emission adjustment interval PNI) in which light is not emitted is provided in the emission period PIL. During this period, the potential of the lighting control line ILM becomes LOW, and the lighting control switch SWI and the emission signal control switch SWF are turned OFF. FIG. 4D is a diagram illustrating states of the switches at this timing.

Also in the above-mentioned pixel circuit PC, the current path from one power supply to another power supply is not provided in the precharge period PPR. The drive transistor TRD may be turned ON at the beginning of the data storing period PDW simply by electrically connecting the node NA and the node NB to each other. Therefore, data may be written without accompanying light emission, and the precharge voltage necessary at the beginning of the data storing period PDW may be supplied independently of the voltage drop. As a result, the non-uniform in-plane luminance due to the hysteresis caused by the voltage distribution resulting from the voltage drop may be suppressed. Further, non-uniform luminance due to the effect of the hysteresis caused by the gray level of the previous frame is also suppressed compared to the case where the auxiliary capacitor CA is not provided.

### Second Embodiment

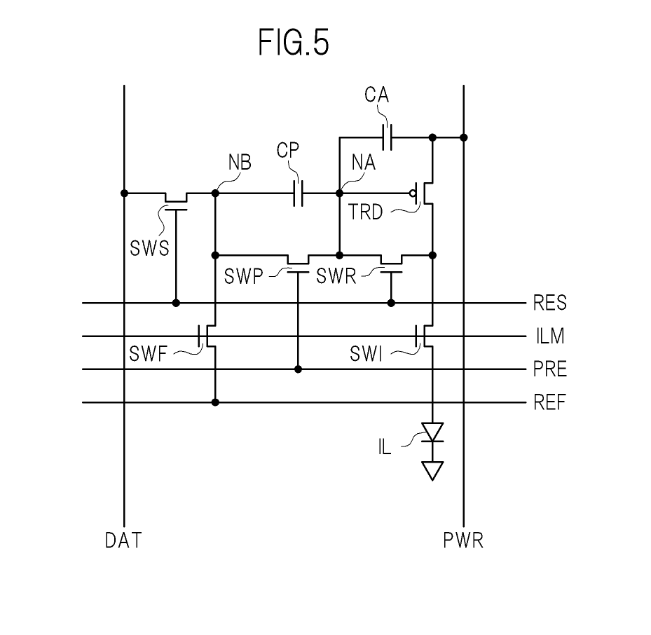

A second embodiment of the present invention is different from the first embodiment mainly in the position of the auxiliary capacitor CA in the pixel circuits PC. Next, the second embodiment is described, mainly focusing on the differences from the first embodiment. FIG. 5 is a circuit diagram illustrating an example of a configuration of a pixel circuit PC according to the second embodiment.

The pixel circuit PC includes a light emitting element IL, a drive transistor TRD, a storage capacitor CP, an auxiliary capacitor CA, a lighting control switch SWI, a reset switch SWR, a selecting switch SWS, an emission signal control switch SWF, and a precharge switch SWP. The light emitting element IL has one end to which a reference potential is supplied by a reference potential supply wiring line (not shown). The storage capacitor CP has one end connected to a gate electrode of the drive transistor TRD. The storage capacitor CP has another end connected to one end of the selecting switch SWS, and another end of the selecting switch SWS is connected to a data line DAT. Further, the another end of the storage capacitor CP is also connected to one end of the emission signal control switch SWF. Another end of the emission signal control switch SWF is connected to the emission control signal line REF. The auxiliary capacitor CA has one end connected to a source electrode of the drive transistor TRD and another end connected to the gate electrode of the drive transistor TRD. The potential difference applied between the both ends of the auxiliary capacitor CA is the gate-source voltage of the drive transistor TRD. The gate electrode and a drain electrode of the drive transistor TRD are connected to each other via the reset switch SWR. Further, the one end of the storage capacitor CP is connected to one end of the precharge switch SWP, and the another end of the storage capacitor CP is connected to another end of the precharge switch. The selecting switch SWS and the reset switch SWR each have a gate electrode connected to a reset control line RES, the lighting control switch SWI and the emission signal control switch SWF each have a gate electrode connected to a lighting control line ILM, and the precharge switch SWP has a gate electrode connected to a precharge control line PRE.

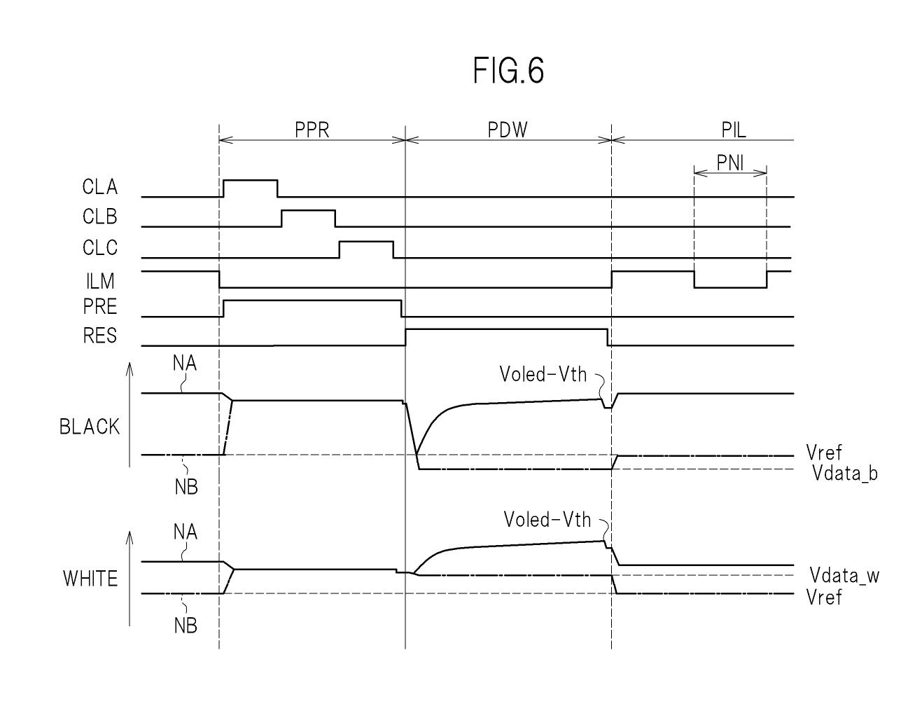

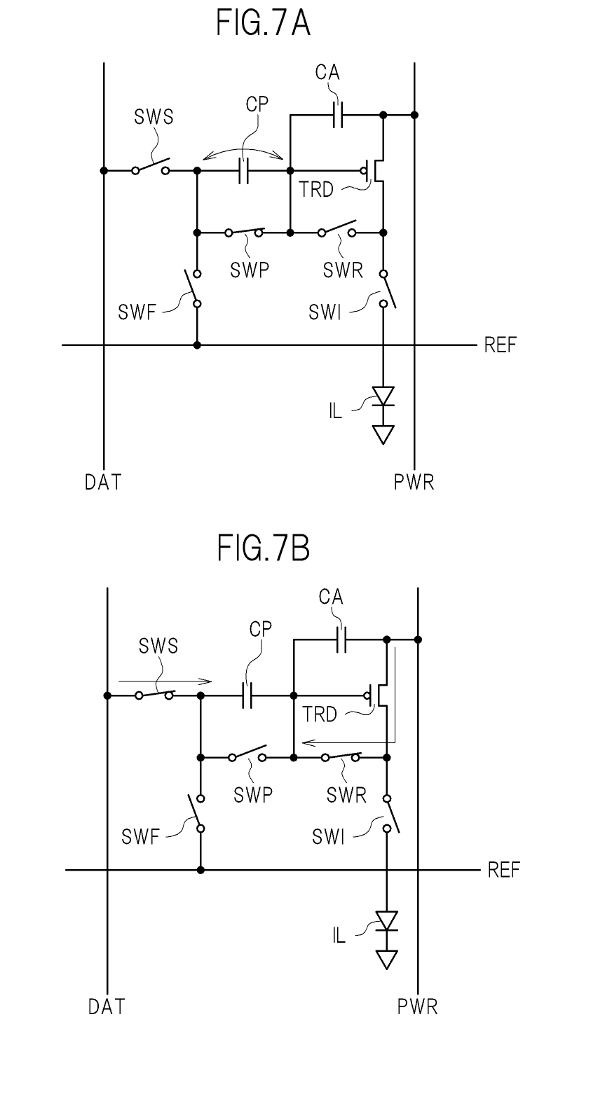

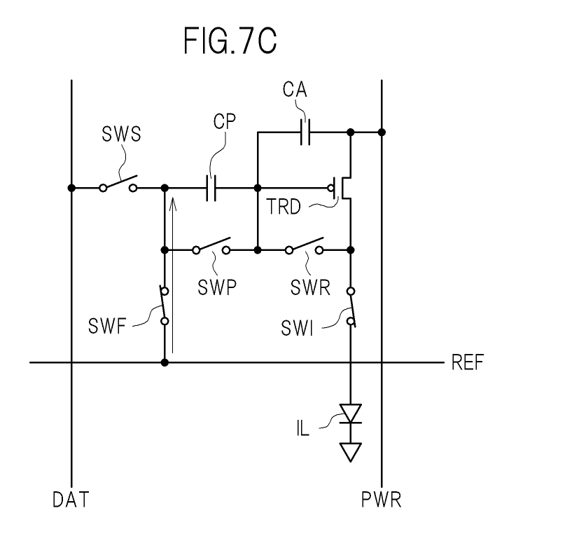

FIG. 6 is a waveform diagram illustrating an example of temporal changes in potentials of RGB change-over control lines CLA, CLB, and CLC, the lighting control line ILM, the precharge control line PRE, the reset control line RES, a node NA, and a node NB of the pixel circuit PC according to the second embodiment of the present invention. This figure corresponds to FIG. 3 in the first embodiment, and signals supplied to the RGB change-over control lines CLA, CLB, and CLC, the lighting control line ILM, the precharge control line PRE, and the reset control line RES are the same as those of the first embodiment. FIGS. 7A to 7C are diagrams illustrating states of the lighting control switch SWI, the reset switch SWR, the selecting switch SWS, the emission signal control switch SWF, and the precharge switch SWP in the pixel circuit PC in the respective periods of the example illustrated in FIG. 6. Referring to FIGS. 6 and 7A to 7C, a driving method, a potential Va of the node NA, and a potential Vb of the node NB are described below.

At the beginning of a precharge period PPR, the lighting control switch SWI is turned OFF, and the precharge switch SWP is turned ON. FIG. 7A is a diagram illustrating states of the switches in the pixel circuit PC at this point in time. The auxiliary capacitor CA connected to the node NA suppresses fluctuation in potential difference between the power supply line PWR and the node NA. Therefore, when the potential Va and the potential Vb become the same potential, the potential is closer to the potential Va before the precharge operation than the potential Vb before the precharge operation. Note that, as with the example of FIG. 3, the data line driving circuit XDV sequentially supplies the data signal to the data lines DATR, DATG, and DATB in the precharge period PPR, and the data lines DATR, DATG, and DATB each store the potential of the data signal.

At the end of the precharge period PPR, the precharge switch SWP is turned OFF. Then, the selecting switch SWS and the reset switch SWR are turned ON in the data storing period PDW. FIG. 7B is a diagram illustrating states of the switches in the data storing period PDW.

Changes in potentials of the node NA and the node NB in the case where the previous frame is black are described. In this case, the potential of the node NA is the potential for turning OFF the drive transistor TRD at the beginning so that the drive transistor TRD does not allow any current to flow therethrough, and the data line DAT supplies the potential Vdata_b (in FIG. 6, the potential at the gray level of black) of the data signal to the node NB. Vdata_b is lower than the potential of the node NB in the precharge period PPR. Therefore, when the change in potential of the node NB is transferred to the gate electrode of the drive transistor TRD through the storage capacitor CP (which is herein referred to as coupling), the gate-source potential difference of the drive transistor TRD expands in the negative direction. When the gate-source potential difference becomes lower than the threshold voltage of the drive transistor TRD, the drive transistor TRD allows a current to flow therethrough. Further, because the lighting control switch SWI is OFF, the node NA is not affected by the reference potential. The drive transistor TRD allows the current to flow therethrough so that the gate-source potential difference reaches to the threshold voltage, in other words, so that the potential Va approaches Voled-|Vth| to increase the potential of the node NA. On the other hand, the potential of the node NB is a potential of the data signal Vdata_b. At the end of the data storing period PDW, the reset switch SWR is turned OFF, and the storage capacitor CP stores the potential difference between the node NA and the node NB. Note that, in actuality, a time constant it takes for the gate-source potential difference to reach to the threshold voltage is longer than the data storing period PDW. Therefore, at the timing when the data storing period PDW ends, the potential Va is smaller than Voled-|Vth|, and the storage capacitor CP stores the potential difference that reflects the potential Va.

Changes in potential of the node NA and the node NB in the case where the previous frame is white are described. In this case, the drive transistor TRD is already ON at the beginning of the data storing period PDW. The effect that the current flowing through the drive transistor TRD increases the potential of the node NA is larger than the effect that the potential of the data line DAT decreases the potential of the node NA through the storage capacitor CP, and hence little decrease in potential Va is observed and the potential of the node NA is increased. Thereafter, as with the case where the previous frame is black, the drive transistor TRD allows the current to flow therethrough to approach the equilibrium state in which the gate-source potential difference reaches to the threshold voltage (Va reaches to Voled-|Vth|). Further, the potential of the node NB is a potential of a data signal Vdata_w, and the storage capacitor CP stores the potential difference between the node NA and the node NB when the reset switch SWR is turned OFF at the end of the data storing period PDW.

In the next emission period PIL, the lighting control switch SWI and the emission signal control switch SWF are turned ON, and the emission signal control switch SWF supplies the reference potential Vref to the node NB. Then, the potential of the node NA changes depending on the potential difference between the potential of the data signal and the reference potential Vref and a ratio between the storage capacitor CP and the auxiliary capacitor CA, to thereby change the gate-source voltage of the drive transistor. FIG. 7C is a diagram illustrating states of the switches at this timing. This causes the light emitting element IL to emit light at a luminance corresponding to the potential of the data signal.

Also in the above-mentioned pixel circuit PC, the current path from one power supply to another power supply is not provided in the precharge period PPR. The drive transistor TRD may be turned ON at the beginning of the data storing period PDW simply by electrically connecting the node NA and the node NB to each other. Therefore, data may be written without accompanying light emission, and the on-voltage of the drive transistor necessary at the beginning of the data storing period PDW may be supplied independently of the voltage drop. As a result, the non-uniform in-plane luminance due to the hysteresis caused by the voltage distribution resulting from the voltage drop may be suppressed.

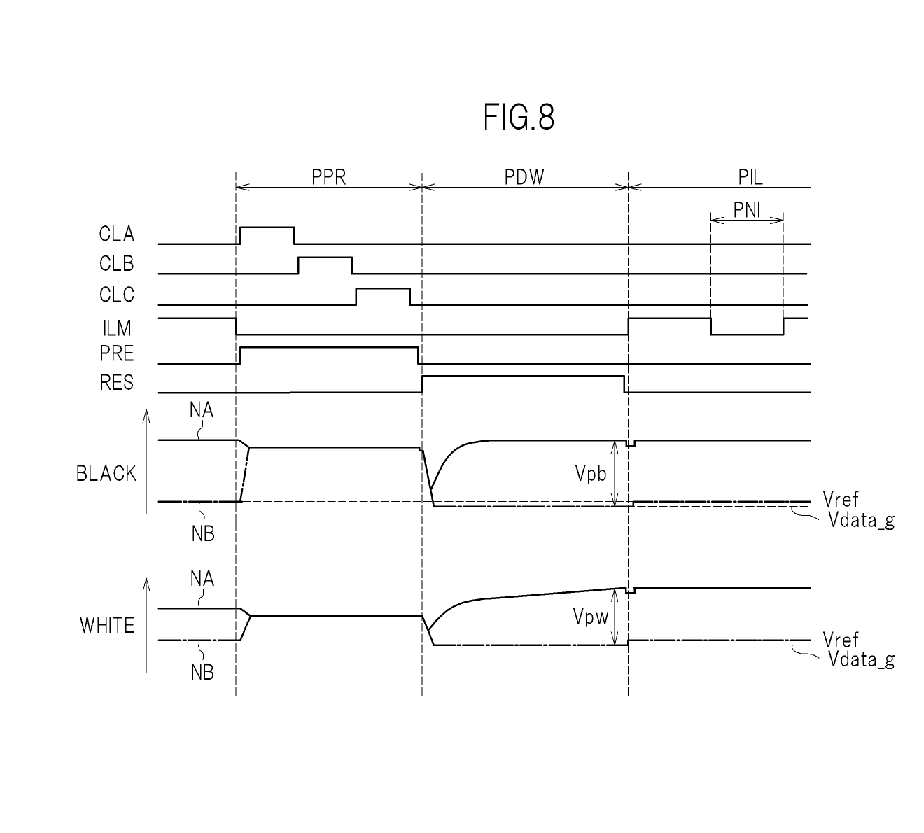

Meanwhile, according to the organic EL display device of this embodiment, the potential of the node NA in the precharge period PPR changes depending on the displayed gray level of the previous frame. This effect is described below. FIG. 8 is a waveform diagram illustrating another example of temporal changes in potentials of the RGB change-over control lines CLA, CLB, and CLC, the lighting control line ILM, the precharge control line PRE, the reset control line RES, the node NA, and the node NB in the case where gray is displayed. In this figure, the potentials of the node NA and the node NB are illustrated for two cases: one where the previous frame displays black and the current frame displays a middle tone (gray) (BLACK in the figure); and the other where the previous frame displays white and the current frame displays a middle tone (gray) (WHITE in the figure). In this example, as opposed to the example of FIG. 6, both in the case where the previous frame displays black and in the case where the previous frame displays white, the gray level to be displayed in the current frame (potential Vdata_g of a data signal to be supplied from the data line DAT to the pixel circuit PC) is the same. When the gray level to be displayed in the current frame is the same, the changes in luminance due to the hysteresis characteristics are easy to compare. Using the example of FIG. 8, the effect of the hysteresis caused by the gray level of the previous frame is described.

In the example of FIG. 8, the potential applied to the gate electrode of the drive transistor TRD in the precharge period PPR is higher in the BLACK case than in the WHITE case. Here, the threshold voltage of the drive transistor at the end of the data storing period PDW in the BLACK case is denoted by Vthb (<0), and the threshold voltage of the drive transistor at the end of the data storing period PDW in the WHITE case is denoted by Vthw (<0). In this case, Vthb>Vthw due to the effect of the hysteresis characteristics. Therefore, the potential (Voted-|Vthb|) to which the node NA approaches in the data storing period PDW in the case where the previous frame is black is larger than the potential (Voted-|Vthw|) to which the node NA approaches in the case where the previous frame is white. The potential difference between the node NA and the node NB at the end of the data storing period PDW in the case where the previous frame is black (Vpb) is larger than that in the case where the previous frame is white (Vpw),that is Vpb>Vpw. The difference in threshold voltage is resolved in the emission period PIL, and hence the emission luminance is changed by the difference between Vpb and Vpw in the end. Specifically, in the case where the previous frame is black, the drive transistor TRD changes so as not to allow any current to flow at the time of light emission and hence the luminance is decreased, and in the case where the previous frame is white, the drive transistor TRD changes so as to allow the current to flow at the time of light emission and hence the luminance is increased. As a result, when a moving image in which a vertical black line moves from right to left in a gray background, for example, the pixels changing from black to gray in gray level assume an intermediate luminance between black and gray. Further, in this embodiment, the gate-source voltage of the drive transistor TRD is a different positive or negative voltage in the precharge period PPR depending on the gray level of the previous frame, and hence a hysteresis in a different direction is stored depending on the gray level, which is another factor that increases the effect of the hysteresis as compared to the first embodiment.

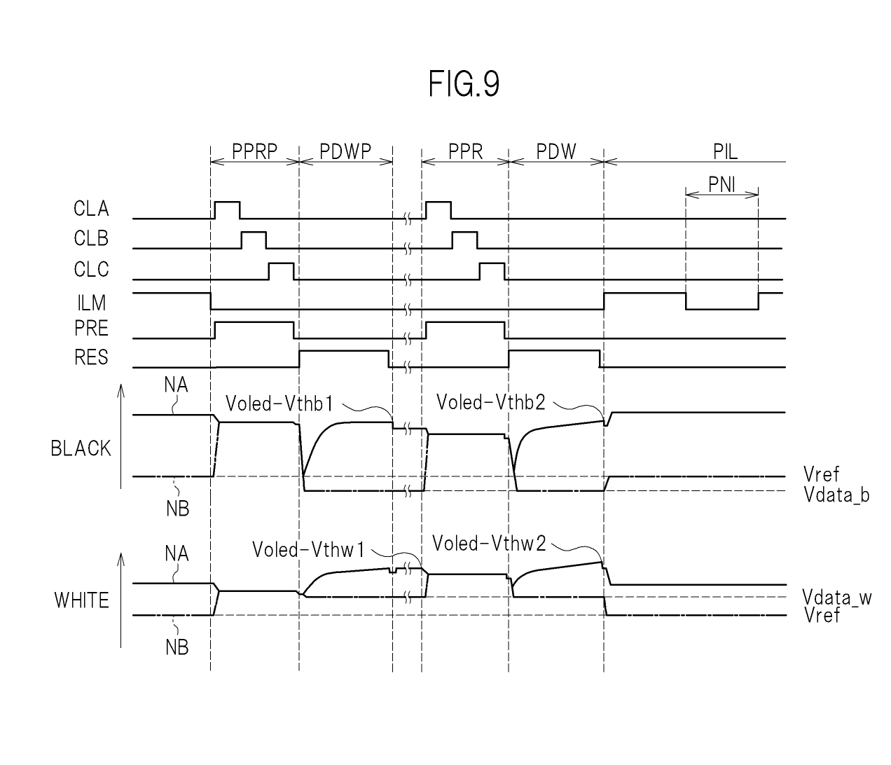

A method of decreasing the effect of the displayed gray level in the previous frame as described above is to repeat the precharge operation and the data storing operation a plurality of times. FIG. 9 is a waveform diagram illustrating an example of a driving method including repeating the precharge operation and the data storing operation a plurality of times. In the example of this figure, the first precharge operation and the first data storing operation are performed on one pixel circuit PC, and then, after a predetermined number of horizontal periods (normally any one of 1 to 8 horizontal periods), the second precharge operation and the second data storing operation are performed thereon before emitting light. Here, a period in which the first precharge operation is performed is referred to as a preceding precharge period PPRP, and a period in which the first data storing operation is performed is referred to as a preceding data storing period PDWP. Further, a period in which the second precharge operation is performed is referred to as a precharge period PPR, and a period in which the second data storing operation is performed is referred to as a data storing period PDW. Then, the pixel circuit PC emits light in the emission period PIL. States of the switches in the precharge operation are the same as the states of the switches in the precharge period PPR of FIGS. 6 and 8. Further, states of the switches in the data storing operation are the same as the states of the switches in the data storing period PDW of FIGS. 6 and 8.

In the preceding data storing period PDWP, the storage capacitor CP stores the potential difference based on the potential indicating the gray level to be displayed by a pixel circuit PC in a row preceding the pixel circuit PC of interest. This is because the original data signal is input in the data storing period PDW, and because the horizontal period including the preceding data storing period PDWP and the horizontal period including the data storing period PDW are different. In this case, at the timing at which the preceding data storing period PDWP ends, the potential of the node NA is a potential that is determined from the potential of the power supply line PWR and the threshold voltage of the drive transistor TRD, and the difference in potential of the node NA between the case where the previous frame is black and the case where the previous frame is white is due only to the difference in threshold voltage. This difference is smaller than the difference in potential of the node NA in the preceding precharge period PPRP between the case where the previous frame is black and the case where the previous frame is white. Therefore, the difference in threshold voltage (hysteresis) between the case where the previous frame is black and the case where the previous frame is white is further resolved, and the difference in threshold voltage at the end of the second data writing operation is further reduced. As a result, the difference in gray level at the time of light emission is suppressed.

### Third Embodiment

A third embodiment of the present invention is different from the pixel circuit PC in the first embodiment mainly in the points that the emission signal control switch SWF is a p-channel thin film transistor having an opposite polarity to that of the reset switch SWR, and that the gate electrode of the transistor is connected to the reset control line RES. Next, the third embodiment is described, mainly focusing on the differences from the second embodiment.

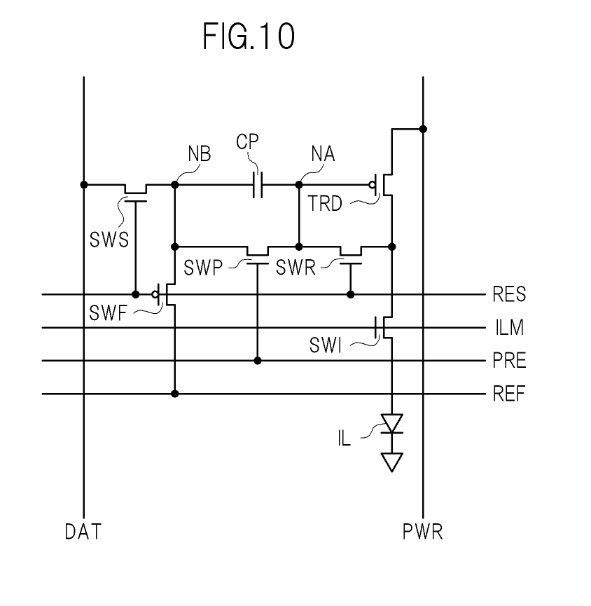

FIG. 10 is a circuit diagram illustrating an example of a configuration of a pixel circuit PC according to the third embodiment. The pixel circuit PC includes a light emitting element IL, a drive transistor TRD, a storage capacitor CP, a lighting control switch SWI, a reset switch SWR, a selecting switch SWS, an emission signal control switch SWF, and a precharge switch SWP. The light emitting element IL has one end to which a reference potential is supplied by a reference potential supply wiring line (not shown). The storage capacitor CP has one end connected to a gate electrode of the drive transistor TRD. The storage capacitor CP has another end connected to a data line DAT via the selecting switch SWS, and the another end of the storage capacitor CP is also connected to an emission control signal line REF via the emission signal control switch SWF. The gate electrode and a drain electrode of the drive transistor TRD are connected to each other via the reset switch SWR. Further, the one end of the storage capacitor CP is connected to one end of the precharge switch SWP, and the another end of the storage capacitor CP is connected to another end of the precharge switch SWP. The selecting switch SWS, the reset switch SWR, and the emission signal control switch SWF each have a gate electrode connected to the reset control line RES, the lighting control switch SWI has a gate electrode connected to a lighting control line ILM, and the precharge switch SWP has a gate electrode connected to a precharge control line PRE.

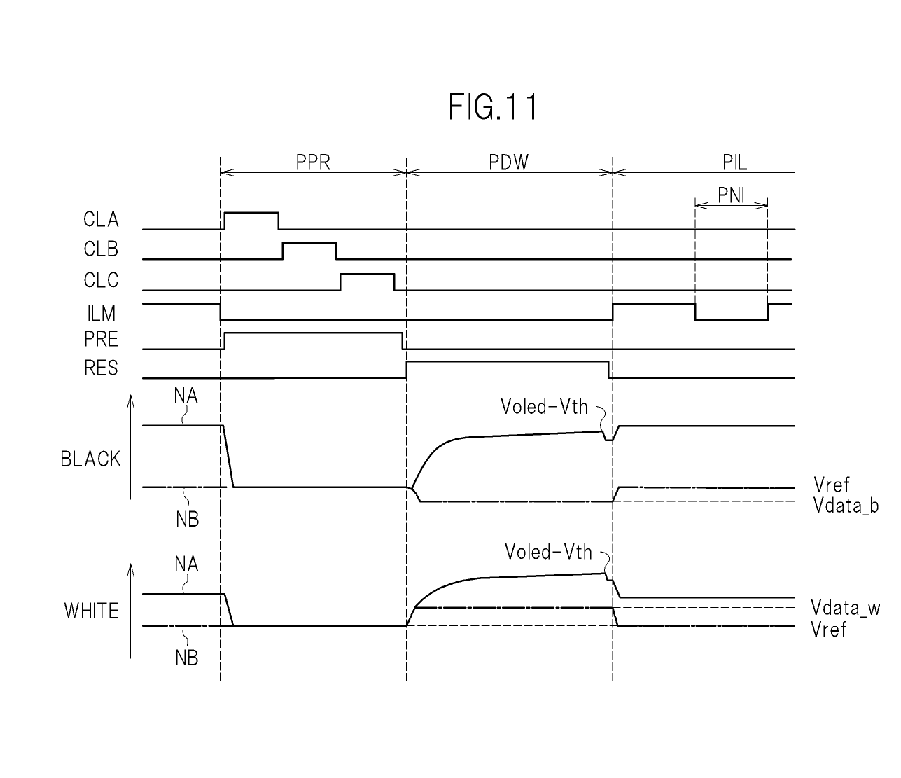

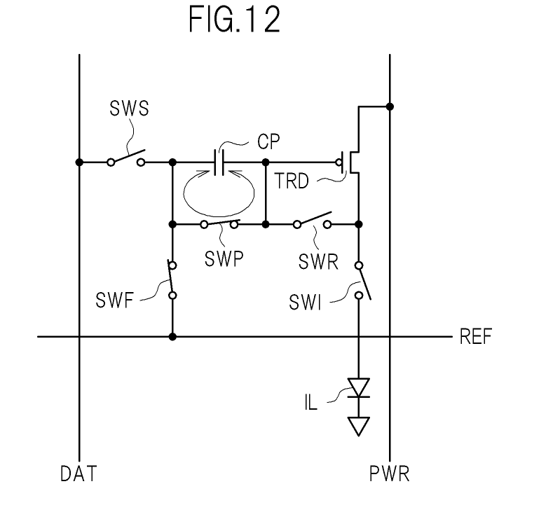

FIG. 11 is a waveform diagram illustrating an example of temporal changes in potentials of RGB change-over control lines CLA, CLB, and CLC, the lighting control line ILM, the precharge control line PRE, the reset control line RES, a node NA and a node NB of the pixel circuit PC according to the third embodiment of the present invention. This figure corresponds to FIG. 3 in the first embodiment. Signals supplied to the RGB change-over control lines CLA, CLB, and CLC, the lighting control line ILM, the precharge control line PRE, and the reset control line RES are the same as those of the first embodiment. The largest difference between this embodiment and the first embodiment is that, in this embodiment, the emission signal control switch SWF is turned ON in the precharge period PPR. FIG. 12 is a diagram illustrating states of the switches in the pixel circuit PC in the precharge period. In the precharge period PPR, the reference potential Vref is supplied to the node NB and the node NA from the emission control signal line REF, and the potentials of the node NA and the node NB become the reference potential Vref. Further, because the potential of the node NB is connected to the reference potential Vref, the increase in potentials of the node NA and the node NB due to coupling with the precharge control line PRE does not occur, and the increase in on-state resistance of the precharge switch SWP does not occur. Therefore, there is no need for the auxiliary capacitor CA.

Accordingly, a potential Va of the node NA in the precharge period PPR after the precharge switch SWP is turned ON becomes constant irrespective of the gray level in the previous frame, and the gate-source voltage of the drive transistor TRD is further increased in the negative direction as compared to the first embodiment. When such large potential is applied in the negative direction, the effect of hysteresis due to the gate-source voltage of the drive transistor TRD in the precharge period PPR is larger than that of hysteresis due to the gate-source voltage of the drive transistor TRD in the previous frame, and the effect of hysteresis caused by the gray level of the previous frame is reduced. Note that, the supply of the potential of the data signal in the precharge period PPR, and operations in the data storing period PDW and the emission period PIL (except for the emission adjustment interval PNI) are the same as in the second embodiment, and redundant description thereof is omitted.

Note that, in this embodiment, the emission control signal line REF is ON also in the emission adjustment interval PNI to supply the reference potential Vref to the node NB, but there is no effect on the light emission of the light emitting element IL because the lighting control switch SWI is OFF.

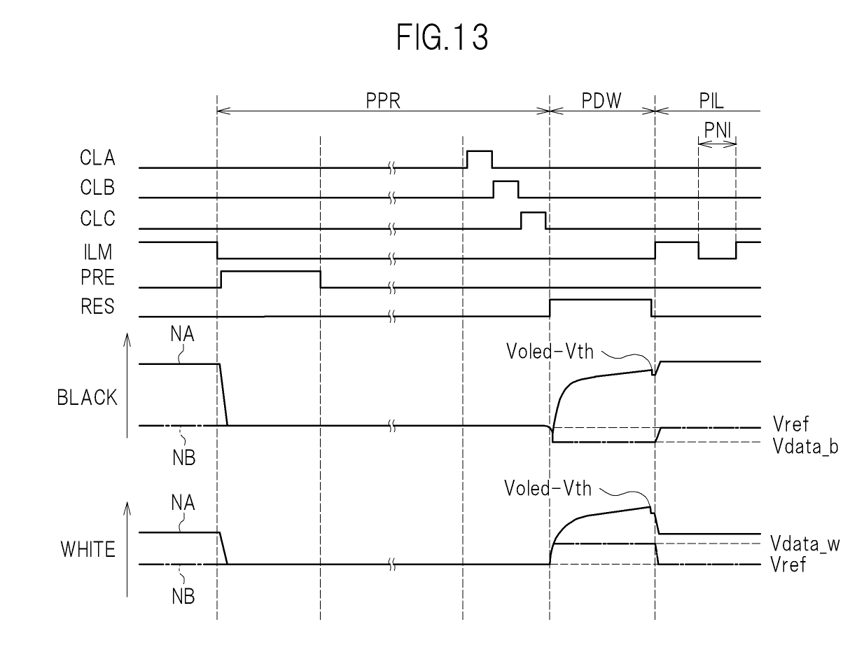

Here, the precharge operation in the third embodiment is performed irrespective of the potential from the data line DAT, and hence the precharge operation may be performed to overlap the data storing period PDW of the pixel circuit PC in another row. FIG. 13 is a waveform diagram illustrating another example of temporal changes in the potentials of the RGB change-over control lines CLA, CLB, and CLC, the lighting control line ILM, the precharge control line PRE, the reset control line RES, the node NA, and the node NB of the pixel circuit PC according to the third embodiment of the present invention. In this figure, a driving method in which the precharge period PPR is longer than the example of FIG. 11 by 1 to 10 horizontal periods is described. Note that, writing of the data signal from the data line driving circuit XDV to data lines DATR, DATG, and DATB is performed at the end of the precharge period PPR. Of the precharge period PPR, a combined period of a period in which the data signal is written to the data lines DATR, DATG, and DATB and the data storing period PDW is 1 horizontal period.

In the third embodiment, the emission signal control switch SWF is turned ON and the reset switch SWR is turned OFF in the precharge period PPR. Therefore, the drive transistor TRD may be turned ON at the beginning of the data storing period PDW without providing a path for a current to flow from a power supply to the precharge switch SWP. As a result, the non-uniform in-plane luminance due to the hysteresis caused by the voltage distribution resulting from the voltage drop may be suppressed. Further, the state in which the potential Va of the node NA is stable is maintained longer than the example of FIG. 11, and hence the effect of the hysteresis caused by the gray level in the previous frame may be further reduced. In addition, as opposed to the example of FIG. 9 in the second embodiment, there is no need for the preceding data storing period PDWP for stabilizing the potential of the node NA, and hence the hysteresis caused by the gray level in the previous frame may be resolved even when the period from the time when the precharge operation is performed until the data signal is stored is reduced accordingly. Note that, such driving method involving setting the precharge period PPR to be longer than 1 horizontal period may be applied to the pixel circuit PC described in the first embodiment with reference to FIG. 2. This is because, also in the first embodiment, the precharge operation is performed irrespective of the potential from the data line DAT. As with the example of FIG. 13, the effect of the hysteresis caused by the gray level in the previous frame may be further reduced as compared to the example of FIG. 3.

### Fourth Embodiment

A fourth embodiment of the present invention is different from the first embodiment in that the selecting switch SWS included in the pixel circuit PC is controlled by a selection control line SEL, which is a wiring line provided separately from the reset control line RES. Next, the fourth embodiment is described, mainly focusing on differences from the first embodiment.

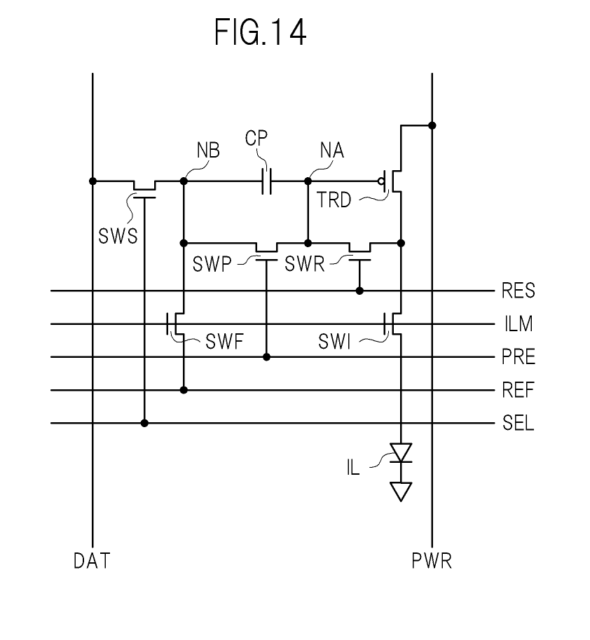

One selection control line SEL is provided for each row of the pixel circuits PC, and has one end connected to a vertical scanning circuit YDV. FIG. 14 is a circuit diagram illustrating an example of a configuration of a pixel circuit PC according to the fourth embodiment. The pixel circuit PC includes a light emitting element IL, a drive transistor TRD, a storage capacitor CP, a lighting control switch SWI, a reset switch SWR, a selecting switch SWS, an emission signal control switch SWF, and a precharge switch SWP. The light emitting element IL has one end to which a reference potential is supplied by a reference potential supply wiring line (not shown). The storage capacitor CP has one end connected to a gate electrode of the drive transistor TRD. The storage capacitor CP has another end connected to a data line DAT via the selecting switch SWS, and the storage capacitor CP has another end connected to an emission control signal line REF via the emission signal control switch SWF. The drive transistor TRD has the gate electrode and a drain electrode connected to each other via the reset switch SWR. The one end of the storage capacitor CP is also connected to one end of the precharge switch SWP, and the another end of the storage capacitor CP is also connected to another end of the precharge switch. The selecting switch SWS has a gate electrode connected to the selection control line SEL, the reset switch SWR has a gate electrode connected to the reset control line RES, the lighting control switch SWI and the emission signal control switch SWF each have a gate electrode connected to a lighting control line ILM, and the precharge switch SWP has a gate electrode connected to a precharge control line PRE.

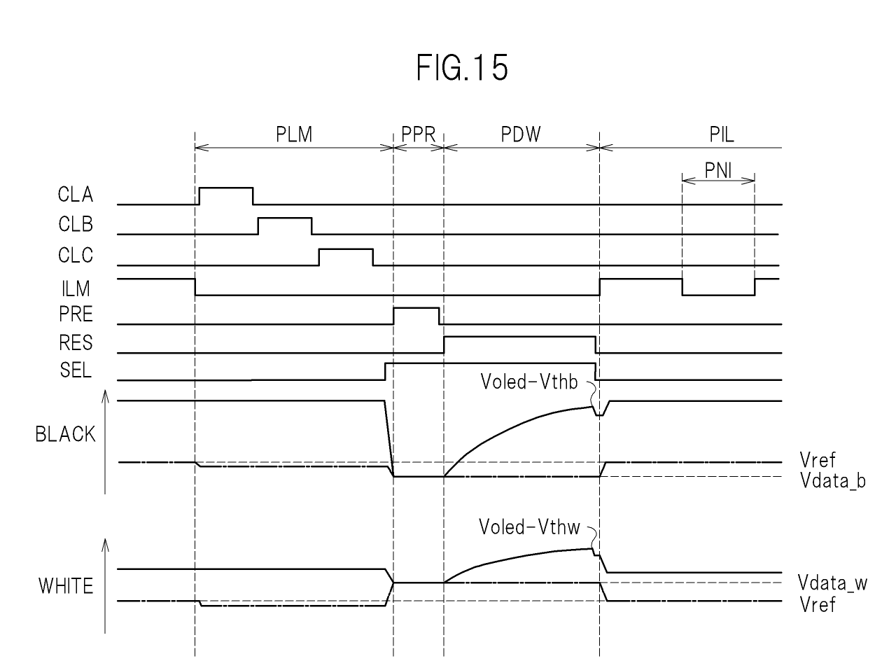

FIG. 15 is a waveform diagram illustrating an example of temporal changes in potentials of RGB change-over control lines CLA, CLB, and CLC, the lighting control line ILM, the precharge control line PRE, the reset control line RES, the selection control line SEL, a node NA, and a node NB of the pixel circuit PC according to the fourth embodiment of the present invention. This figure corresponds to FIG. 3 in the first embodiment. In this embodiment, driving one pixel circuit is performed in the order of an operation of storing a potential difference in the data line DAT, a precharge operation, a data writing operation, and an emission operation. In this embodiment, the precharge period PPR is preceded by a data storing period PLM, which is a period in which the operation of storing the potential difference in the data line DAT is performed. In this example, a combined period of the data storing period PLM, the precharge period PPR, and the data storing period PDW is 1 horizontal period (1H).

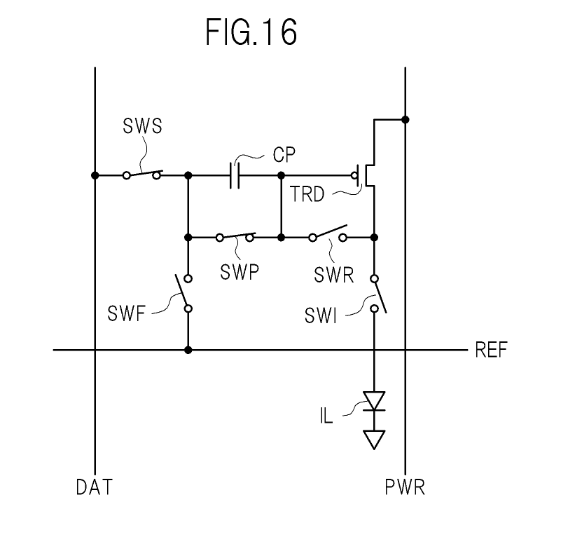

Before the data storing period PLM, the light emitting element IL emits light at the gray level of the previous frame. In other words, the pixel circuit is in the emission period PIL of the previous frame. In the emission period PIL of the previous frame, the node NA has a potential corresponding to the gray level at which the light is emitted. Then, in the data storing period PLM, the potential of the lighting control line ILM becomes LOW and the lighting control switch SWI is turned OFF. This stops light emission of the light emitting element IL. In this state, the data line driving circuit XDV sequentially supplies the data signal to the data lines DATR, DATG, and DATB, and the data lines DATR, DATG, and DATB store the potential of the data signal. Immediately before the next precharge period PPR, the potential of the selection control line SEL becomes HIGH and the selecting switch SWS is turned ON, and in the precharge period PPR, the potential of the precharge control line PRE becomes HIGH and the precharge switch SWP is turned ON. FIG. 16 is a diagram illustrating states of the switches in the pixel circuit PC at this point in time. The node NA and the node NB are connected to the data line DAT. A potential Va of the node NA and a potential Vb of the node NB become the potential of the data signal stored in the data line DAT. Next, the potential of the reset control line RES becomes HIGH and the data storing period PDW starts. At the point in time when the data storing period PDW starts, the potential Va of the node NA varies for a case where the current frame is black and a case where the current frame is white. However, both in the case where the current frame is black and in the case where the current frame is white, the potential of the node NA is a potential for turning ON the drive transistor TRD, and hence the drive transistor TRD allows a current to flow so that the gate-source potential difference reaches to the threshold voltage. On the other hand, the potential of the node NB is a potential of a data signal Vdata_b, and the storage capacitor CP stores the potential difference between the node NA and the node NB when the reset switch SWR is turned OFF at the end of the data storing period PDW.

In the next emission period PIL, the potential of the lighting control line ILM becomes HIGH, and the lighting control switch SWI and the emission signal control switch SWF are turned ON to supply the reference potential Vref, which is a potential for light emission, to the node NB so that the light emitting element IL emits light.

As described above, even when the current path from one power supply to another power supply is not provided in the precharge period PPR, the drive transistor TRD may be turned ON at the beginning of the data storing period PDW simply by electrically connecting the node NA and the node NB to each other. Therefore, data may be written without accompanying light emission, and the on-voltage of the drive transistor necessary at the beginning of the data storing period PDW may be supplied independently of the voltage drop. As a result, the non-uniform in-plane luminance due to the hysteresis caused by the voltage distribution resulting from the voltage drop may be suppressed. Note that, the precharge operation is performed after the operation of storing the potential of the data signal in the data line DAT in order to prevent the potential to be stored in the data line DAT from fluctuating by performing the operations at the same time.

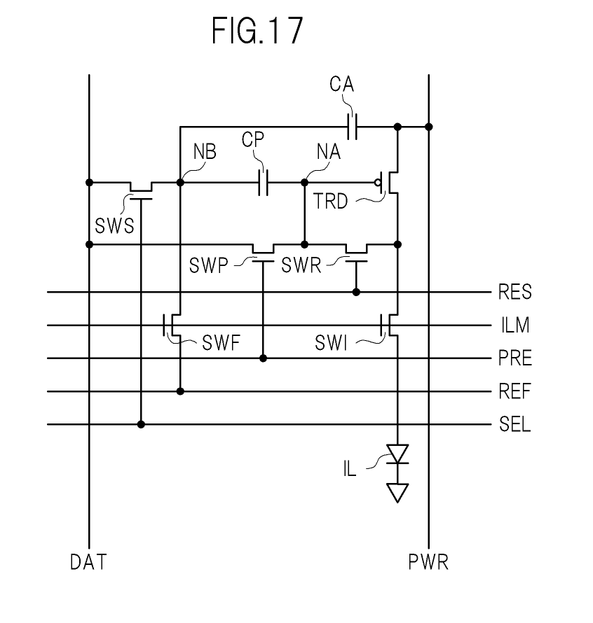

Note that, the configuration of the pixel circuit PC is not limited to that illustrated in FIG. 14. For example, an auxiliary capacitor CA may have one end connected to the node NA and another end connected to the source electrode of the drive transistor TRD. Further, the one end of the precharge switch SWP may be connected to a place other than the one end of the storage capacitor CP. FIG. 17 is a circuit diagram illustrating another example of the configuration of the pixel circuit PC according to the fourth embodiment of the present invention. The configuration of the pixel circuit PC illustrated in this figure is different from the configuration illustrated in FIG. 14 in that the one end of the precharge switch SWP is connected to the data line DAT, and in that there is provided an auxiliary capacitor CA having one end connected to the node NB and another end connected to the source electrode of the drive transistor TRD. Note that, the another end of the precharge switch SWP is connected to the node NA. Also in the configuration illustrated in FIG. 17, the driving method as illustrated in FIG. 15 may be used to electrically connect the both ends of the storage capacitor CP to each other in the precharge period PPR and hence obtain the effects similar to those of the example illustrated in FIG. 14. Further, the configuration illustrated in FIG. 17 may be modified to a configuration in which one end of the auxiliary capacitor CA is connected to the node NA and another end thereof is connected to the source electrode of the drive transistor TRD.

Further, the driving method may be modified from that described above. Even when the reset switch SWR is turned ON, the emission signal control switch SWF is turned OFF, and the selecting switch SWS is turned OFF in the precharge period PPR, the path of the current flowing from the power supply to the precharge switch SWP may be interrupted. Therefore, the non-uniform in-plane luminance due to the hysteresis caused by the voltage distribution resulting from the voltage drop may be suppressed. Note that, the precharge period PPR and the data storing period PLM may not necessarily be separated.

Further, the present invention may be applied to a further embodiment.

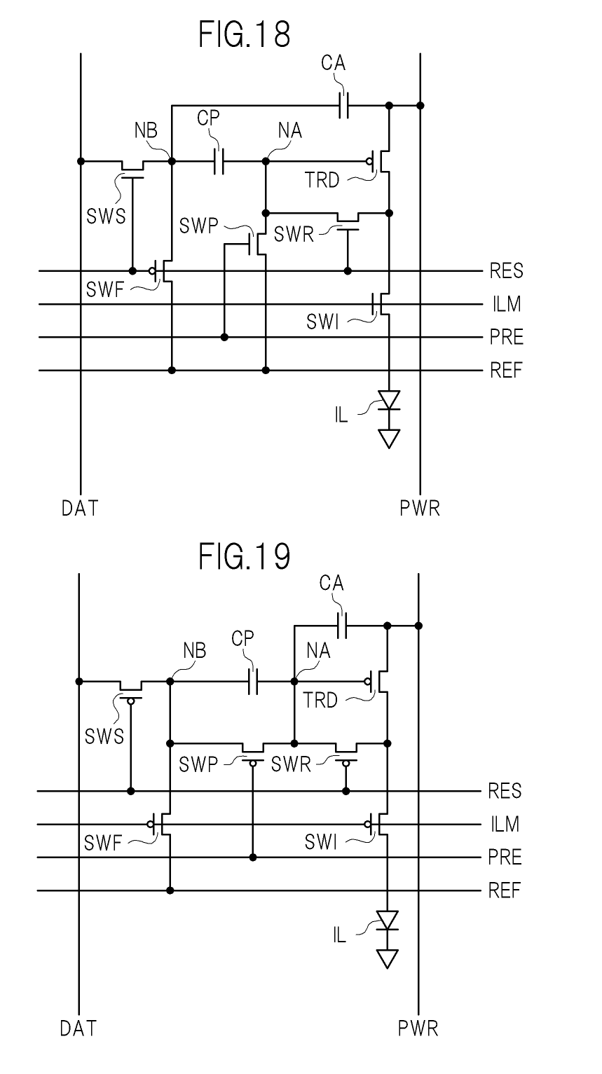

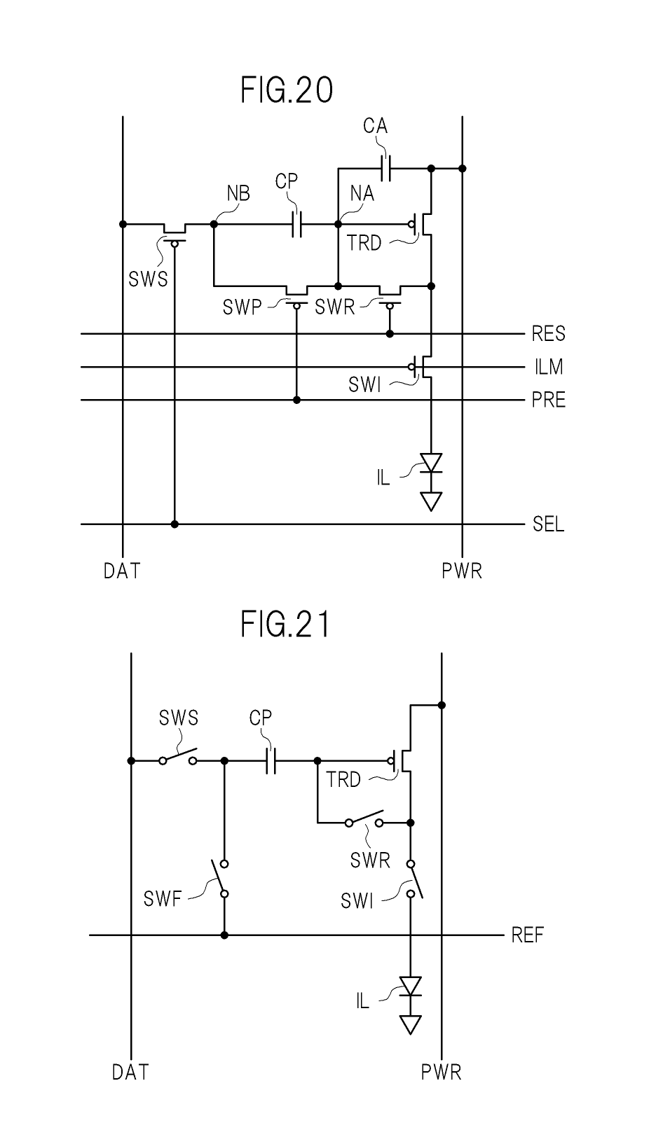

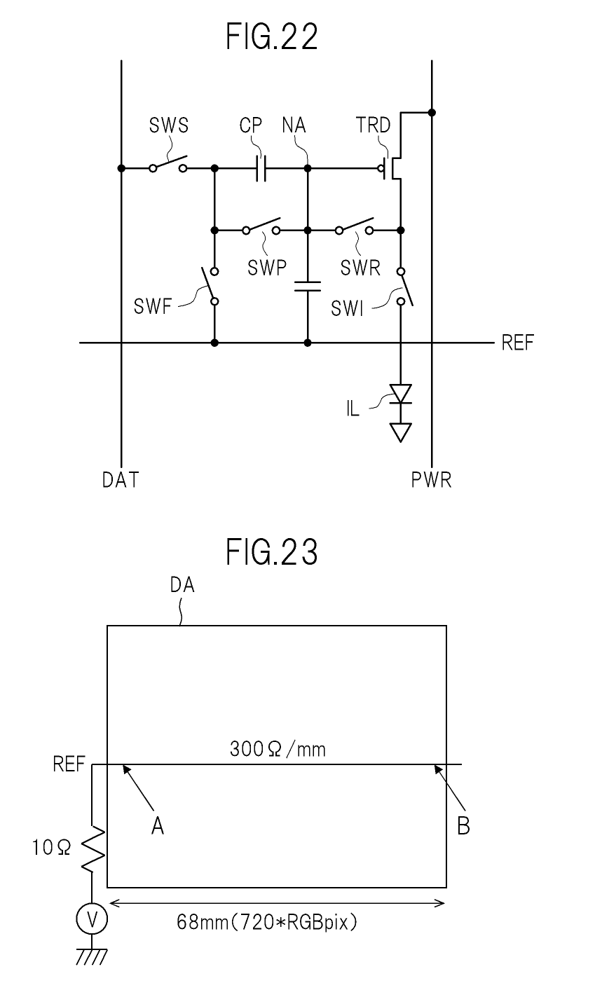

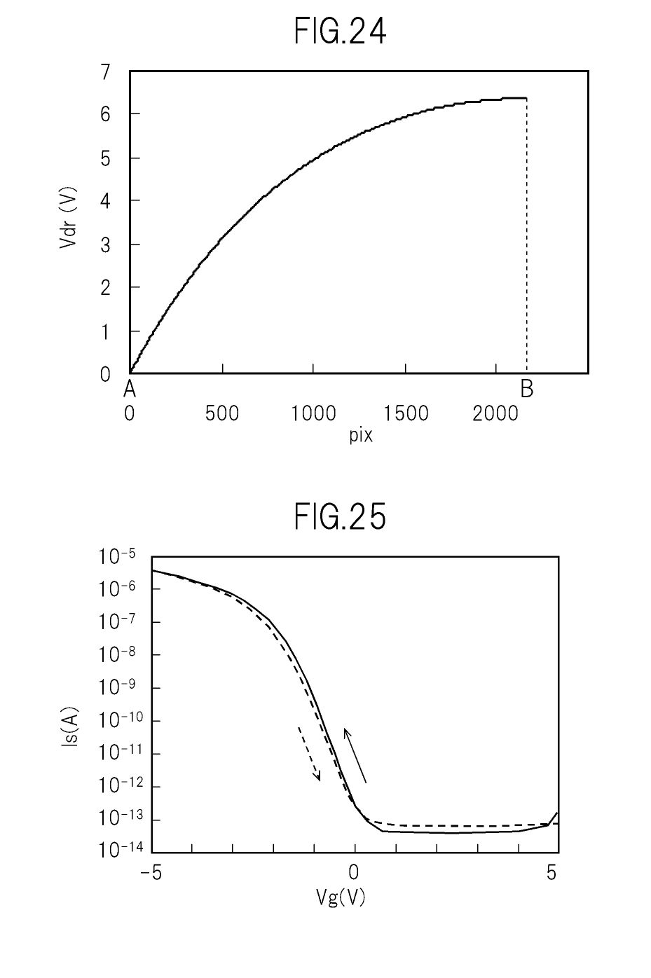

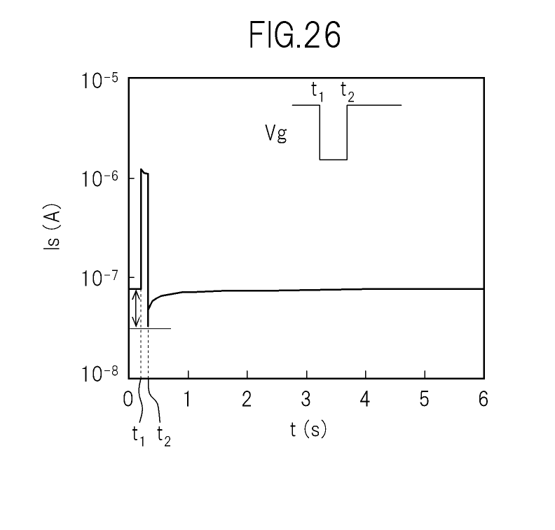

For example, the one end of the precharge switch SWP that is not on the node NA side included in the pixel circuit PC illustrated in FIG. 10 may be connected to the emission control signal line REF. FIG. 18 is a diagram illustrating an example of the pixel circuit in which the one end of the precharge switch SWP is connected to the emission control signal line REF. Also in the pixel circuit PC illustrated in this figure, the driving method illustrated in FIG. 11, for example, may be used to obtain the effects similar to those in the third embodiment. Note that, one end of the auxiliary capacitor CA may be connected to the node NA and another end thereof may be connected to the source electrode of the drive transistor TRD. Further, p-channel thin film transistors may be used for all the switches in the pixel circuit PC. FIG. 19 is a diagram illustrating an example of a pixel circuit PC consisting only of the p-channel thin film transistors. This figure illustrates a circuit configuration in which the switches in the pixel circuit PC illustrated in FIG. 5 are replaced by the p-channel thin film transistors. For example, the similar effects may be obtained by reversing the LOW and HIGH potentials of the signals supplied to the lighting control line ILM, the precharge control line PRE, and the reset control line RES illustrated in FIG. 6. Further, a configuration without the emission control signal line REF may be employed. FIG. 20 illustrates an example of a pixel circuit PC without the emission control signal line REF. The current path from the power supply line PWR to the data line DAT is interrupted by the reset switch SWR while the precharge switch SWP is turned ON, and then data is written, to thereby suppress the non-uniform in-plane luminance due to the hysteresis caused by the voltage drop.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image display device, comprising:
a plurality of pixel circuits;
a power supply line;
a data line for supplying a data signal to the plurality of pixel circuits;
a control line for controlling the plurality of pixel circuits; and
a control circuit for supplying a control signal to the control line, wherein:
each of the plurality of pixel circuits comprises:
a light emitting element;
a drive transistor for controlling light emission of the light emitting element;
a storage capacitor provided between the data line and a gate electrode of the drive transistor;
a both-end connection switch for connecting both ends of the storage capacitor to each other; and
a current interruption switch for interrupting a path of a current flowing from the power supply line to the both-end connection switch; and
the control circuit supplies the control signal to the control line before the data line supplies the data signal to each of the plurality of pixel circuits, the control signal causing the both-end connection switch included in corresponding one of the plurality of pixel circuits to connect the both ends of the storage capacitor to each other, and causing the current interruption switch included in corresponding one of the plurality of pixel circuits to interrupt the path of the current.

2. The image display device according to claim 1, wherein the current interruption switch included in each of the plurality of pixel circuits is provided between a drain electrode and the gate electrode of the drive transistor included in corresponding one of the plurality of pixel circuits.

3. An image display device, comprising:
a plurality of pixel circuits;
a power supply line; and
a data line for supplying a data signal to the plurality of pixel circuits,
wherein each of the plurality of pixel circuits comprises:
a light emitting element having one end to which a reference potential is supplied;
a drive transistor;
a lighting control switch having one end connected to a drain electrode of the drive transistor and another end connected to another end of the light emitting element;
a storage capacitor having one end connected to a gate electrode of the drive transistor;
a reset switch provided between the gate electrode and the drain electrode of the drive transistor;
a both-end connection switch having one end connected to the one end of the storage capacitor and another end connected to another end of the storage capacitor;
an auxiliary capacitor having one end connected to one of the one end and the another end of the storage capacitor; and
a selecting switch having one end connected to the data line and another end connected to the another end of the storage capacitor.

4. An image display device, comprising:
a plurality of pixel circuits;
a power supply line;
an emission control signal line for supplying an emission control signal for causing the plurality of pixel circuits to emit light; and
a data line for supplying a data signal to the plurality of pixel circuits,
wherein each of the plurality of pixel circuits comprises:
a light emitting element having one end to which a reference potential is supplied;
a drive transistor;
a lighting control switch having one end connected to a drain electrode of the drive transistor and another end connected to another end of the light emitting element;
a storage capacitor having one end connected to a gate electrode of the drive transistor;
a reset switch provided between the gate electrode and the drain electrode of the drive transistor;
a both-end connection switch having one end connected to the one end of the storage capacitor and another end connected to another end of the storage capacitor;
an auxiliary capacitor having one end connected to one of the one end and the another end of the storage capacitor;
a selecting switch having one end connected to the data line and another end connected to the another end of the storage capacitor; and
an emission signal control switch having one end connected to the emission control signal line and another end connected to the another end of the storage capacitor.

5. A driving method for an image display device comprising a power supply line, a data line, and pixel circuits each including a light emitting element, a drive transistor for controlling light emission of the light emitting element, a storage capacitor provided between the data line and a gate electrode of the drive transistor, and a both-end connection switch for connecting both ends of the storage capacitor to each other, the driving method comprising:
a precharge step of connecting the both ends of the storage capacitor to each other through the both-end connection switch, and interrupting a path of a current flowing from the power supply line through the both-end connection switch;
after the precharge step, a data storing step of inputting, by the data line, a data signal to one end of the storage capacitor on the data line side; and
after the data storing step, an emission step of supplying an emission control signal to the one end of the storage capacitor to cause the light emitting element to emit light.

6. The driving method for an image display device according to claim 5, wherein:
the drive transistor has a source electrode to which a power supply potential is supplied; and
the precharge step comprises connecting the both ends of the storage capacitor to each other through the both-end connection switch, and interrupting the path of the current between a drain electrode and the gate electrode of the drive transistor.

7. The driving method for an image display device according to claim 5, wherein the precharge step comprises setting the both ends of the storage capacitor to a floating state.

8. The driving method for an image display device according to claim 5, wherein:
the image display device further comprises an emission control signal line; and
the precharge step comprises supplying a potential to the one end of the storage capacitor on the data line side through the emission control signal line.

9. The driving method for an image display device according to claim 5, wherein the precharge step is performed for a period longer than one horizontal period.

10. The driving method for an image display device according to claim 5, wherein the precharge step comprises supplying a potential to the one end of the storage capacitor through the data line.

11. The driving method for an image display device according to claim 5, wherein a combination of the precharge step and the data storing step is repeated before the emission step is performed.
